(19) United States
(12) Patent Application Publication
(10) Pub. No.: US 2005/0010446 A1
(43) Pub. Date: Jan. 13, 2005

(54) Health benefit plan monitoring system and method

(76) Inventors: Todd Loren Lash, Oakland, CA (US); Martin Richard Fisher, Severna Park, MD (US); Todd Ashley Fisher, Severna Park, MD (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/888,244

(22) Filed: Jul. 9, 2004

Related U.S. Application Data
(60) Provisional application No. 60/486,268, filed on Jul. 11, 2003.

(51) Int. Cl. G06F 17/60

(52) U.S. Cl. 705/2

(57) ABSTRACT

End-user software for monitoring health care benefits and maintaining individual personal health histories is disclosed. The software provides the ability for a user to monitor health care services delivered by a plurality of different health care providers, such as doctors, clinics, dentists, pharmacies, etc. under a plurality of different health benefit plans to a plurality of different individuals, such as members of an immediate or extended family. Specific medical events are logged and tracked, and payment information associated with the events can be reconciled, kept open and/or marked for follow-up action. Various planning tools are available to assist the user in making health care decisions, such as which plan to choose and when to make discretionary purchases of health care related goods and services. The software is able to download information from health care providers, health benefit plans, etc.

### FIELD OF THE INVENTION

The present invention relates to systems and methods for monitoring health care delivery, and is particularly related to software for tracking and reconciling payments and entitlements under health care plans, for maintaining health care related financial and tax records, and for maintaining medical history and health care benefit information.

### BACKGROUND OF THE INVENTION

In the United States the complexity of the health care system is often overwhelming to users of the system. Health care, which is used herein in its broadest sense, is delivered by a large number of independent or loosely related entities, including doctors, hospitals, pharmacists, non-M.D. specialists (e.g., psychologists, optometrists, physical therapists, nurse practitioners, chiropractors, acupuncturists, etc.), and a substantial portion of the overall finding is provided under a large number of publicly and privately operated health benefit plans. There is wide variability among the available health benefit plans and, frequently, the health benefit plans have complex rules and procedures governing what is “covered” by the plan, how much the plan will pay, and how payment is made.

Among the large segment of the U.S. population that has some type of health benefit plan (sometimes referred to as health “insurance”) a large proportion is required to pay at least a portion of the expense of covered items. For example, many plans have annual and lifetime “deductibles” and co-payment requirements, which may vary depending on the type of service, e.g., the plan deductibles and co-payments may be dramatically different for mental health benefits than for other types of medical services. Likewise, many plans strictly limit the specific health care providers that may be used, the frequency of certain services, the specific medical procedures or events that are covered, or offer different coverage or reimbursement amounts and procedures depending on whether the provider is “in,” “affiliated,” or “out” of the plan. For example, a “preferred provider” plan might directly pay ninety percent of the charges by a doctor who is a member of the plan. On the other hand, it might pay only eighty percent of the charges of doctor who is not a plan member, and the payment method might be limited to reimbursement to the user, as opposed to direct payment to the doctor, with the user retaining the responsibility to pay the non-plan doctor. Moreover, reimbursement for a visit to a non-plan doctor might be further limited by what the plan considers reasonable and customary or what the plan has contracted to pay in-network doctors for the specific service provided, such that less than eighty percent of the charged amount is reimbursed.

The rate of inflation in the health care industry is consistently higher than other segments of the economy. One consequence of this is that available plans are becoming more expensive, and the trend is for covered employees to pay a greater proportion of their overall health care expenses.

The complexity to end users is further exacerbated by the fact that many individuals and families have more than one plan that is potentially applicable to their health care needs, but which have different rules and procedures. An individual may have a medical plan, a dental plan, a vision plan and a “cafeteria” or “flexible spending” plan which provides reimbursement for certain expenses, such as deductibles, that are not covered by one of the other plans. Many users are also faced with frequent changes in their health benefit plans, either because they move, they change jobs, they change plans (many employers who provide health benefit plans offer an annual “open enrollment” allowing their employees to switch plans), or, without any action on the user's part, their plan changes its rules, coverages, deductibles or benefit offerings. The change of plans, or the change of plan rules, may occur in the middle of a course of medical therapy, further complicating the user's ability to understand what medical events are covered, and which plan provides coverage. Such changes are frequently the cause of clerical errors, for example, when a provider continues to bill the original plan. These errors can be difficult and time-consuming to correct.

From time-to-time, users are faced with a choice concerning what plan to select. For example, as noted, many employers offer open enrollment which allow employees to switch plans annually. Many factors are likely to be important to a user faced with the choice of whether to switch plans. One factor likely to be considered important to many users is the estimated overall economic impact of available alternatives. In order to assess the comparative economic impact it is useful to be able to estimate what medical services are likely to be required in the upcoming plan period, and how the user's overall out-of-pocket expenses would vary. Such estimates may be made based on historical needs, or based on expected needs that are unrelated to the past, for example the need for major surgery, or on a combination of the two. Whatever approach is deemed appropriate by the user based on his or her individual or family circumstances, it is necessary to comparatively analyze the financial benefits and out-of-pocket expenses under the various available options. This, in turn requires a sound understanding of the rules of the available plans and, potentially, a significant effort applying the rules to the data (whether historical or estimated) in a complex calculation.

Available statistics reveal that the administration of health plans is fraught with error, and that the plans frequently make mistakes in calculating the benefits a user or a service provider is entitled to receive under a plan. It is also common for benefits to be denied due to lack of proper documentation or improper characterization in a claim of the services provided. When a claim is denied, the onus is on the consumer to take action, such as research or other follow-up activities, in order to correct the error and receive the benefits properly due. For the reasons described, and others, it can be extremely difficult, under the best of circumstances, to monitor whether a plan is providing the proper coverage. The difficulty is far greater if the individual user is in the midst of a medical crisis or has diminished capacity. As a practical matter, it is believed that only a small percentage of the population carefully monitors whether their health benefit plans are making mistakes.

As described, the current trends are for individuals to frequently change health plans, for the plans themselves to frequently change, for individuals to pay a greater proportion of their expenses, and for the doctors and other professionals who are “in” or “out” of certain types of plans to frequently change. This flux makes it harder for an individual to manage his or her own health care. It also means that an individual's medical history records are likely to be spread out over a large number of locations, making it increasingly difficult for health professionals to obtain an accurate and clear medical history of the individual. The rules implemented under HIPPA increase the difficulty associated with sharing medical history information. The practical result of these changes is that the individual is now to a large degree personally responsible for maintaining his or her own medical history and for accurately informing new health care providers of that history. Thus, for example, most new doctor visits require the individual to complete a detailed and thorough form describing the individual's medical history. Unfortunately, most individuals rely on memory to furnish such information, creating a substantial and potentially dangerous risk that pertinent information will be forgotten or overlooked.

Finally, users often have the ability to time their purchases of medical services and devices, and the timing can effect the benefits available to the user. For example, many cafeteria or flex-benefit plans will fully cover medical services and devices which are not covered by other plans, up to an annual maximum amount. Typically, such plans provide benefits on an annual “use-it-or-lose-it” basis. Or, individuals may wish to schedule medical services in a year that they have exceeded their annual plan deductible. In order for users to take full advantage of the benefits available to them under such plans, it is important to carefully track medical expenses and reimbursements, so that the timing of purchase decisions can be made with an eye towards minimizing the cost to the user and taking full advantage of available benefits. The ability to make the most economically advantageous decisions may depend on understanding the coverages and benefits associated with a number of different medical benefit plans.

Currently, there are no products available to end-users to addresses the many problems, some of which have been described, associated with the complexity of the health care system and available medical benefit plans. As a consequence, most users do a poor job understanding and dealing with their health plans.

### SUMMARY OF THE INVENTION

Accordingly, it is an object of the present invention to enable users to manage their health benefit plans, including enabling users to monitor a plurality of medical events for a plurality of individuals and to reconcile and track the processing of benefits available under their plans for such medical events.

Another object of the present invention is to enable users to conveniently calculate the proper benefit amounts available for one or more medical events under a plurality of medical plans.

A further object of the present invention is to enable users to compare plans in connection with their specific anticipated medical needs.

Yet another object of the present invention is to provide a convenient system for users to maintain their medical history.

Still another object of the present invention is to provide an automated system to enable users to download and utilize rules, forms, medical history information explanations of benefits, etc., associated with one or more medical plans or health care providers.

A further object of the present invention is to enable users to conveniently file claims, assess claim actions, make claim inquiries and file appeals, whether such actions are done using paper forms or online.

Still another object of the present invention is to provide an automated system to remind users via pop-up, email, and other types of alert mechanisms in order to follow-up on claims, and authorizations, and manage the process obtaining their health care benefits.

These and other objects of the present invention are realized in a software program for individuals covered by health benefit plans to assist them, inter alia, with monitoring, reconciling, tracking, calculating available medical benefits, for making claims and filing protests and appeals, for maintaining health information, for planning, and for automating these processes.

In one aspect the present invention comprises a software program for reconciling health care benefits having a subroutine for entering payment rules of at least one health benefit plan into a computer storage system, a subroutine for entering transaction data for a medical event associated with an individual covered by said health benefit plan into said computer storage system, a subroutine for determining the amount of payment said health benefit plan is required to provide for said medical event and for identifying who is entitled to receive said benefit payment, a subroutine for reconciling that the correct benefit payment amount has been provided by said health benefit plan to the correct payee, and a subroutine for alerting a user of any error in the benefit payment and for providing the user with at least one option for following up on said error.

In another aspect, the present invention comprises a software program for reconciling health care benefits having a subroutine for entering payment rules of a plurality of health benefit plans into a computer storage system accessible to the software program, a subroutine for entering personal information about a plurality of individuals into a computer storage system accessible to the software program, a subroutine for entering payee information associated with persons who are entitled to receive benefit payments under said health benefit plans, a subroutine for entering transaction data for medical events associated with said individuals into a computer storage system accessible to the software program, a subroutine for determining whether a medical event entered into said computer storage system is covered by one or more of said health benefit plans and the amount of payment and identity of the payee each health benefit plan is required to provide for said medical event.

In yet another aspect the present invention comprises a software program for managing health care benefits having a subroutine for entering payment rules of at least one health benefit plan into a computer storage system accessible to the software program, a subroutine for entering payee information associated with at least one person who is entitled to receive benefit payments under said health benefit plan, a subroutine for entering prescription data for medicines prescribed to said individual into a computer storage system accessible to the software program, said prescription data including prescription renewal data and prescription source data; a subroutine for providing reminders to the software user of the need to renew prescriptions, applicable rules associated with prescription renewal under the health benefit plan, and the estimated cost of renewal.

In still another aspect, the present invention comprises a software program for tracking health care benefits having a subroutine for entering payment rules of at least one health benefit plan into a computer storage system, a subroutine for entering transaction data for medical events associated with at least one individual covered by said health benefit plan into said computer storage system, a subroutine for identifying whether a medical event is compensable under said health benefit plan and for determining the identify of the payees entitled to receive compensation under said health benefit plan, a subroutine for providing status information about payments said health benefit plan is required to provide for said medical event, a subroutine for alerting the user of status information about benefit payments associated with said medical event.

In a further aspect, the present invention is directed to a software program for assisting a user realize the available benefits under at least one health benefit plan and at least one flexible spending account, which may be used to provide supplement benefit, wherein said flexible spending account has a plan coverage period, having a subroutine for entering data about the medical events occurring during the plan coverage period and storing said medical event data in a computer storage system, a subroutine for tracking the benefits paid by said health benefit plan during said plan coverage and storing said benefit payment information in a computer storage system, a subroutine for tracking payments received from said flexible spending account during said plan period and storing said data in a computer storage system, a subroutine for tracking out-of-pocket expenses paid in connection with said medical events and storing said data in a computer storage system, a subroutine for calculating and reporting the amount available in said flexible spending account for the current plan period.

In yet another aspect, the software of the present invention allows users to manage the data from a plurality of documents relating to medical events or relating to their medical history by entering and storing the data from such documents into the software. Such documents may be electronic or paper documents. Paper documents may be scanned and their images stored by the software for later access by the user.

### BRIEF DESCRIPTION OF THE DRAWINGS

The foregoing aspects and the attendant advantages of the present invention will become more readily apparent by reference to the following detailed description when taken in conjunction with the accompanying drawings. The figures display features of the inventive software, not all of which are described in detail in the following description of the invention. However, many inventive features will be apparent to those skilled in the art from the content of the figures.

FIG. 1 is a “screen shot” of the initial or “home page” of the user interface of an embodiment of the software of the present invention.

FIG. 2 is a screen shot of a window for entering and storing basic information about an individual.

FIG. 3 is a screen shot of a window for displaying, entering and storing additional profile information about an individual.

FIG. 4A is a screen shot of a window for displaying, entering and storing medical history information concerning an individual's allergies, and FIG. 4B is a screen shot of a form for displaying, entering and storing medical history information about a condition.

FIG. 5 is a screen shot of a window for displaying, entering and storing medical history information about an individual's family.

FIG. 6 is a screen shot of a window for entering and storing basic information about a new health benefit plan.

FIGS. 7A-7D are screen shots of windows of displaying, entering and storing information about a health benefit plan.

FIG. 8 is a screen shot of a window for displaying activity information for a health benefit plan.

FIG. 9 is a screen shot of a window for displaying claim information relating to a health benefit plan.

FIG. 10 is a screen shot of a window for displaying plan rule information.

FIG. 11 is a screen shot of a window for displaying, entering and storing information about a flexible spending plan.

FIG. 12 is a screen shot of a window for displaying, entering and storing basic information about a health care provider.

FIGS. 13A-13C are screen shots of windows, for displaying, entering and storing information about a pharmacy and related prescription information.

FIGS. 14A-14D are screen shots of windows of a wizard for entering and storing information about a medical event.

FIGS. 15A-15G are screen shots of windows comprising a medical for displaying, entering and storing information about a medical event.

FIG. 16 is a screen shot of a window for entering data for a record search.

FIG. 17 is a screen shot of a window for adding and storing a reminder.

### DETAILED DESCRIPTION OF THE PREFERRED EMBODIMENTS

The present invention is directed to computer software having a variety of features that enable users to deal with the complexities of health care and, in particular, health benefit plans. Most health care provided in the United States is at least partially paid for, in one way or another, by a variety of different types of private and public health benefit plans. As used herein, the term “health benefit plan” is intended to broadly describe the various plans and insurance products whereby end users are provided with or reimbursed for health care services and products, or whereby providers of health care related services or products are paid. Thus, the term “health benefit plan” encompasses traditional reimbursement plans, health maintenance organizations (“HMOs”), preferred provider plans (“PPO”), major medical plans, dental plans, vision plans, flexible benefit plans, Medicaid, Medicare, drug benefit plans, supplemental health insurance plans, health savings accounts and the like. Such plans may be provided by an individual's employer or union, or by the government, or may be purchased directly by the individual.

Frequently, an individual's health care needs may be covered by more than one such health benefit plan, either because the individual has multiple plans with overlapping coverage (e.g., both a PPO and a flex-benefit plan, such that the latter will pay for expenses not covered by the former), or because the individual is covered as a family member under multiple plans, (e.g., a child entitled to receive benefits under both his mother's and father's health benefit plans). To date, there is no uniformity in the various health care plans, such that each of the applicable plans will have its own set of rules, exclusions, deductibles, methods of payment, claim procedures, appeal procedures, etc., and, as noted, one or more of these may change on an annual basis. It seems unlikely that there will be any greater uniformity in the near future due to the competitive nature of the private insurance industry.

Under most health benefit plans in the United States, the covered individual has some component of personal financial responsibility including, for example, payment of all or a portion of the insurance premium amounts, a flat and/or percentage “co-pay” associated with doctor visits, prescriptions, etc., or complete financial responsibility for non-covered medical events. In addition, the extent of financial responsibility for a medical event may be tied to annual individual deductibles, annual family deductibles, fee caps (e.g., “reasonable and customary”), annual maximum benefits, lifetime maximum benefits, etc. The applicable payment rules vary widely depending on the type of plan, and may vary within a single plan depending on the services provided—for example, a dental plan might reimburse an individual for the entire cost of x-rays and a dental examination, after payment of an annual deductible, but for only fifty percent of the cost of fillings and crowns, subject to an annual maximum. In addition, there may be limits on the frequency or number of certain types of services, e.g., not more than one set of dental x-rays each year.

The clear trend is towards greater individual financial responsibility for health care expenditures. This trend is reflected in employers requiring their employees to pay a greater proportion of the plan premiums, and in larger co-pays, lower plan benefits, etc. This trend makes it increasingly valuable for individuals to monitor whether they are receiving the full extent of the benefits to which they are entitled and to have the ability to compare plan economics.

As discussed in detail in the “Background of the Invention” section above, it is a very daunting task for users to understand and deal with the myriad of different plan rules, procedures, etc. However, failure to do so can be costly—both because of the frequency of mistakes and because proper understanding and planning enables users to make better decisions. The software of the present invention is a tool that greatly simplifies a user's ability to understand and to plan.

In general, as used herein the term “user” refers to the person or persons who operate the software of the present invention, while the term “individual” refers to a person who is a patient or who is otherwise covered or entitled to benefits under a health benefit plan. Normally, health care providers and health benefit plans interact with the specific individuals who receive health care related services (unless the person is a child or otherwise lacks legal capacity). The distinction is made because a single “user” may operate the software to monitor several “individuals,” such as family members. However, the meaning of these terms may be somewhat dependent on the context.

For convenience, the present application uses the term “medical event” to broadly embrace the various types of discrete services and products which may be covered by a health benefit plan. Thus, a medical event, as used in its broad sense herein, may be used to encompass a wide variety of transactions, such as consultations and services provided by health care professionals (such as doctors, psychiatrists, dentists, physical therapists, registered nurse practitioners, chiropractors, acupuncturists, podiatrists, optometrists, etc.), in-patient or out-patient services provided at a health care facility (such as a hospital, nursing home or rehabilitation center), and procurement of health related products (such as pharmaceuticals, glasses and contact lenses, prosthetic devices, hearing aids, appliances, etc.). For practical purposes, a medical event may be thought of as anything which is potentially reimbursable under a health benefit plan, which is potentially tax deductible, which may be pertinent to the individual's medical history, or which the individual otherwise considers health related and, therefore, chooses to track. The individual or entity which provides the product or service is referred to herein as a health care “provider.” Thus, a provider may be an individual health care professional, such as a doctor or a speech therapist, or it may be an institution, such as a clinic or a pharmacy. As used herein, information about a medical event is entered into the software in the form of a “medical record” and the terms “medical event” and “medical record” are sometimes used interchangeably. It will be appreciated that the term “medical history” is used in the broad sense to include not only the summary information that is typically maintained by health care providers, but also detailed information that an individual may wish to track. Thus, the term medical history as used herein, is sometimes referred to as a personal health history.

It will be appreciated that it is possible to characterize different transactions in more than one way. Thus, a hospital visit might be considered a single medical event, or it might be considered as a series of related medical events. For purposes of the present invention, it is up to the user to decide whether to characterize a transaction as one or multiple medical events, and to enter the records accordingly. As described below, the present invention provides mechanisms for grouping related medical events.

Depending on the context the following terms are used herein to describe various medical events and combinations of events: (1) “Condition”—is used to describe a grouping of related medical events and records that enables all of the pertinent records to be accessed together. A condition might be a chronic or ongoing disease, such as diabetes or arthritis, or a single course of therapy of limited duration, such as a back injury which requires doctor visits, physical therapy and medication. (2) “Event” (as opposed to “medical event” which, as described above, has a broad meaning)—is used to describe a plurality of related records associated with a specific occurrence. Thus, an event may be an emergency room visit for a car accident or a hospital visit for a hip replacement surgery, each of which involves medical records for a variety of different providers. (3) “Record” (as opposed to “medical record” which, as described above, may have a broad meaning)—is used to describe a related group of services, usually associated with a single provider. Thus, a visit to a doctor's office may result in a bill which itemizes a variety of specific procedures performed by the doctor. (4) “Service”—is used to describe a specific services rendered by a provider. Thus, a visit to an optometrist might involve an eye examination, a contact lens fitting and a glaucoma test, each of which is separately itemized on the optometrist's bill, and each of which is, therefore, considered to be a “service” as used herein.

The software of the present invention may be written in any convenient programming language, and may be compiled to run on any convenient operating system. In one embodiment, the source code for the software was written in C, C++, XML and SQL and compiled to run on the GNU Linux and WINDOWS® operating systems. The software may be: (1) stored in and run on a stand alone personal computer (“PC”), or (2) it can be stored and run from elsewhere on a private or public network, such as the internet, that is connected to a computing device operated by the user, or (3) any combination of these two—i.e., some program subroutines and data may be stored and run or accessed locally, while others are stored or run over a network. A PC may be a desktop, laptop, notebook, or tablet computer. Other computing devices which may use the software of the present invention, or a reduced version of the software, include “personal digital assistants” (“PDAs”), cell phone/PDA combination devices, pocket computers and the like. The software may be configured, for example, to synchronize with a PDA so that calendar information, prescription information, medical history information, etc. is readily accessible to the user on a highly mobile device.

In one embodiment, the program is written to be installed, stored and run locally on a PC. Preferably, no matter what type of computing platform is used, the software of the present invention is adapted to access information over the internet, and/or other public networks, as described below in further detail.

In describing the software of the present invention, reference is made to program components as “subroutines”. This term is intended to be used in a very broad sense. Modern software programs are typically distributed over a large number of discrete files that are loaded into memory and accessed and/or executed as needed. Thus, the term “program” or “software” is broadly used to mean the overall collection of files and other program elements used by the computing system. Some of these may have stand-alone functionality. The term subroutine is used herein to describe any portion of the overall program used to achieve or perform a specific task or function or set of related tasks or functions. Thus, a subroutine may be a section of code that is loaded into volatile memory and is “called” by the program as needed, or it may one or more separate executable, data or other files that are loaded into volatile memory and used as needed. As described, the various subroutines which comprise the software of the present invention may be stored and accessed either locally or remotely, or some combination of the two.

Those skilled in the art will understand that some basic functions, such as machine level interactions with the computer hardware, will be performed by the operating system of the computing device under the general command of the software. For present purposes, the term “operating system” includes the computer's BIOS. Thus, storage of data to computer memory and access to the internet will be intermediated by the operating system. While the operating system is not considered part of the present invention, some of the functionality of the invention relies on its ability to call on the operating system to perform functions such as reading or writing to or from memory. Thus, for example, when it is stated that the program stores information in memory, it will be understood that this means that the program directs the operating system to do so.

As is described in detail herein, important functions of the software of the present invention are the storage and maintenance of various data, such as user profile information, user medical history information, health benefit plan information, medical event information and reconciliation information. Depending on the context, the term software, as used herein, sometimes includes the data entered by the user. This data may be stored in any form of non-volatile memory, either locally or at any convenient location on a public or private network. Preferably, because of the potential sensitivity of the information, it is stored in a secure manner. In a preferred embodiment some or all of the data is stored in a relational database to facilitate use and linking of the information and the generation of user-defined reports.

Initially, the software program of the present invention may be installed on a local computing device, such as a PC, in a conventional manner, such as by running an installation program. The necessary files for installation may be located on a removable storage medium, such as a compact disk and run locally, or may be located on a remote server and run from a remote location. In one embodiment, an installation program may be downloaded from the internet and run locally in order to locally store and set up the program on a PC. Where the installation program is made available via the internet, it may be provided for a trial purposes. The trial version of the software may have some features disabled or may be programmed to become non-functional at the end of a trial period unless a key is purchased and entered by the user. Preferably, the program is configured to obtain and install program updates, upgrades, “fixes” and “patches” and the like online, either automatically or as requested by the user. Similarly, the program is preferably configured to periodically and automatically update plan information to the extent such information is available online, as described below.

After installation, the software is launched either automatically or by the user in a typical manner, as by “clicking” on a software icon on the “desktop” of a graphical user interface (“GUI”) on a display screen associated with the PC. In one embodiment, when first run the program may run a subroutine comprising a set-up wizard guiding the user through the process of registering the program, establishing an optional password to control future access to the program, configuring the basic “look and feel” of the program interfaces, etc. As used herein, and as used in the software art, the term wizard refers to a question and answer tree, usually presented in a series of program windows, which guides the user in entering information or in setting up and configuring a program. The windows presented to the user may be context sensitive and related to the answer or information previously entered.

According to the preferred embodiment of the present invention, the program also has one or more additional subroutines comprising set-up wizards to facilitate the entry of basic information used by the program, for example, wizards for guiding the user through the process of entering and storing pertinent information about individuals, medical benefit plans, medical providers and, optionally, year-to-date medical events, payments, etc. Preferably, each of these wizards are automatically launched in succession when the program is first run, after or in conjunction with the initial set-up wizard. The wizards are also available to be run subsequently by the user, as needed, to add additional individuals, medical benefit plans, medical providers, or to modify the information in existing records. Likewise, the preferred embodiment of the present invention includes a subroutine which provides the users with a tutorial which demonstrates use of the program, and teaches the procedures for using the various features and subroutines of the program, including data entry, benefit reconciliation, etc. Preferably, this tutorial is launched automatically the first time the program is used and may be run by the user, as desired, at any time.

In a preferred embodiment the software of the present invention is constructed to download pertinent information, as directed by the user, available via the internet or other computer network from remotely accessible computers, such as a servers hosting internet websites. For example, a step in running the wizard for setting up a medical benefit plan, may include accessing plan information, such as plan rules, via internet download. In such a case, for example, the pertinent plan information may be downloaded from a website operated by the plan, from a website operated by the software provider, or from a website operated by a third party. In a further preferred embodiment, the software of the present invention may be configured to check for updates to the plan information, either automatically or as directed by the user. In addition, the user may be given the option to back-up the data stored and used by the system at a remote location, such at a secure internet site.

It is also contemplated that versions of the software of the present may be distributed by brokers, health benefit plan carriers, employers and the like, preconfigured with information about a specific plan. Such versions may include a reduced set of features or have less flexibility for further customization.

It will be understood that not all medical benefit plans will have information available in a downloadable format. Thus, in accordance with another aspect of the present invention, the software provides the user with access to an updateable list of “links” to available internet websites which contain plan information. Alternatively, or in addition to the list of links, the software provider may maintain a list of links on its own a website which is accessible from within the software, or via an internet “browser.” Since plan information can be complicated, facilitating user access to accurate plan information helps ensure that information maintained by the software is accurate and up to date. Moreover, additional information and tools may be maintained on one or more websites operated by applicable plans or third parties. For example, such websites may have downloadable claim forms, appeal forms and the like, or may provide on-line claims processing. Likewise, a plan may maintain an on-line list of medical providers who are “in” the plan. Similarly, information and tools from health care providers may be downloadable from, linked to or otherwise accessible from the software of the present invention. Links may also be provided by the software to sources of medical information and contact information for any local, state and federal agencies with health care related responsibilities, including, for example, the responsibility for regulating health benefit plans.

According to the preferred embodiment of the present invention, the user is able to bypass the wizards and enter or update the information about individuals, plans, providers, medical events, etc., directly into one or more forms that are accessible from menus on the software interface, as described herein. The various data fields on the forms, or in the corresponding wizards, as the case may be, may be either mandatory or optional. Thus, the form used to store information about an individual may designate the “name” and “date of birth” fields as mandatory, but may set the field for “employment status” as optional.

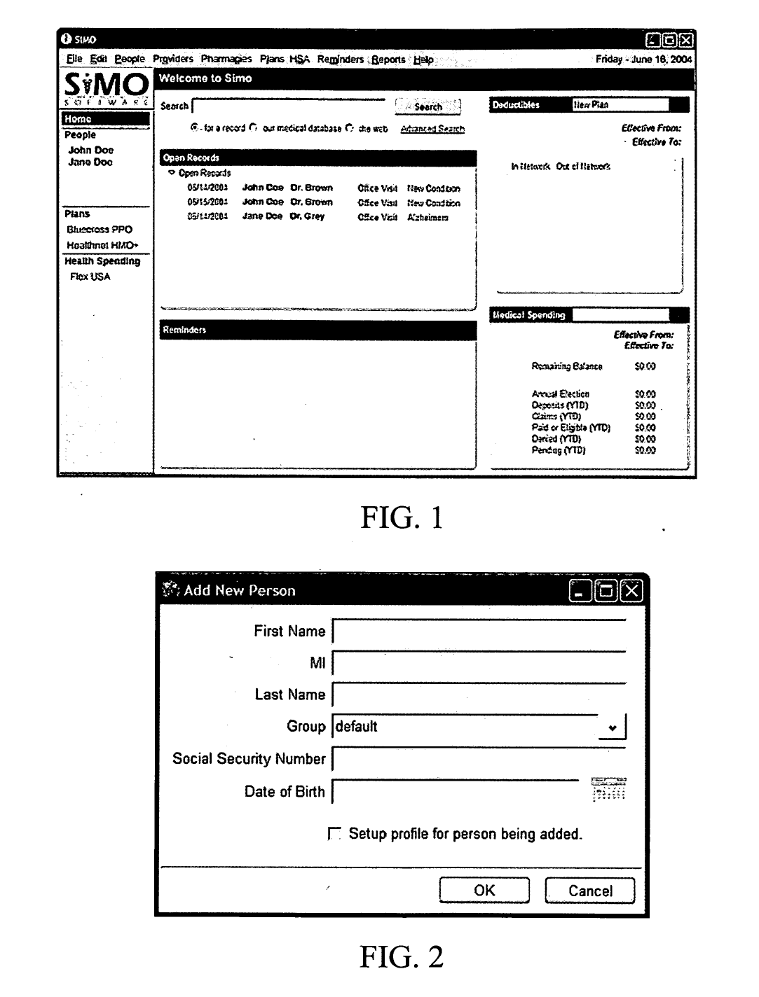

FIG. 1 is a “screen shot” of the initial or “home” display provided by an embodiment of the software of the present invention, after it has been installed and any set-up wizards have been run. The displays conforms to the graphical user interface standards and conventions used in many programs designed for WINDOWS® or MACINTOSH® operating systems. The software interface comprises various context sensitive toolbars providing various menus which typically appear in the upper and/or side border of the program window, providing access to the various software subroutines. As shown in FIG. 1, in addition to a toolbar which has drop-down menus of the type that are standard in many programs, (such as “File” “Edit” and “Help”), the software provides menus and lists for “People” (i.e., individuals), “Providers,” “Pharmacies,” “Plans,” “HSA” (i.e., health savings account), “FSA” (i.e., flexible spending account) “Reminders,” and “Reports”. Pharmacies are treated as a special class of providers that has a separate menu. In one embodiment, the toolbars are customizable by the user.

The opening or “home” screen of FIG. 1 presents a high level overview of the basic data that has been entered into the system. Thus, this screen presents the user with listings of individuals, providers and plans that have been entered, a listing of upcoming appointments and reminders, and expense summaries and menus for entering new information, such as new records relating to a medical event, and for searching existing records for purposes of viewing or modifying them.

FIG. 2 is a screenshot of the initial window presented to the user to add a person to the system. The information entered in this window consists only of the person's name, and if desired, group, date of birth, and social security number. According to the preferred embodiment of the software of the present invention, individuals may be grouped together. For example, a user may decide to create one such group for his or her immediate family (spouse and children), second group for his or her parents and a third group for his or her spouse's parents. This enables different groups to be associated with different plans, and allows easy tracking of related expenses and other information that is pertinent to a group. Thus, in the example given, the grouping might be used to generate schedules of tax-deductible medical expenses for the three groups, each of which files a separate joint tax return. Of course, in many cases the software user will not need to create multiple groups, such that no use will be made of the “group” field.

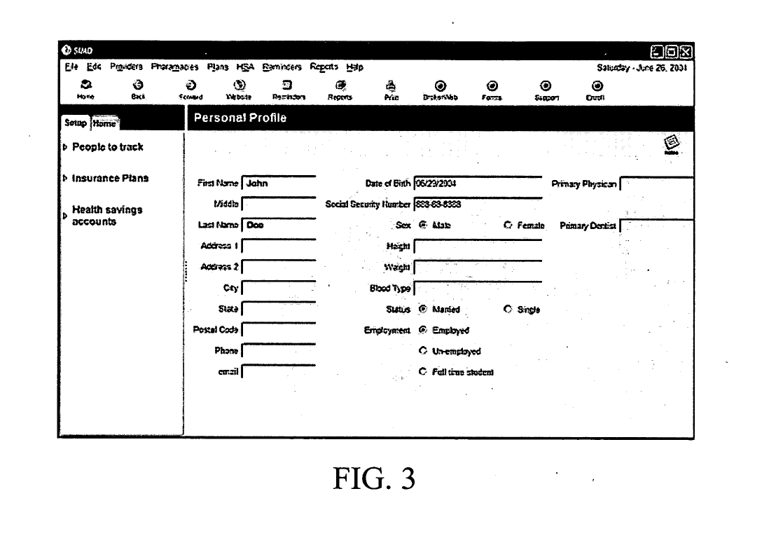

After the individual has been identified and, if applicable, assigned to a group, the user has the option of setting up a profile for the individual. This may be done by checking the “setup profile” box, as shown in FIG. 2, and clicking “OK”. FIG. 3 shows an exemplary user profile record before it has been completed by the user. As described above, the user may provide the information contained in this form either directly, or by running a wizard.

FIG. 3 also shows a “toolbar” at the top of the window, providing direct access to various additional program subroutines, functions and features. Thus, by “clicking” on the appropriate icon on the toolbar, the user can go to the program “home” page, access a list of reminders and forms, launch reporting and print subroutines, access various websites (for example, the websites of the software provider and the various plans and providers entered into the system), etc. In addition, the toolbar has “back” and “forward” functions which are like those used in various web browsers. A list of individuals that have been entered into the system appears at the left column of the screen, as shown in various figures, and the basic information about any of the individuals can be accessed by clicking on the individual's name.

After the individual profile information is entered, the user may then be prompted to enter the individual's medical history. Again, this can proceed using either a wizard or a form. As noted above, the current trend is for individuals to change their health care plans and health care providers more than ever before, and it is increasingly difficult and cumbersome for a new health care providers to gain access to the medical records from prior providers. Thus, the responsibility for maintaining medical history information is increasingly falling on the individual and his or her family. One aspect of the present invention is to facilitate the storage and maintenance of medical history information.

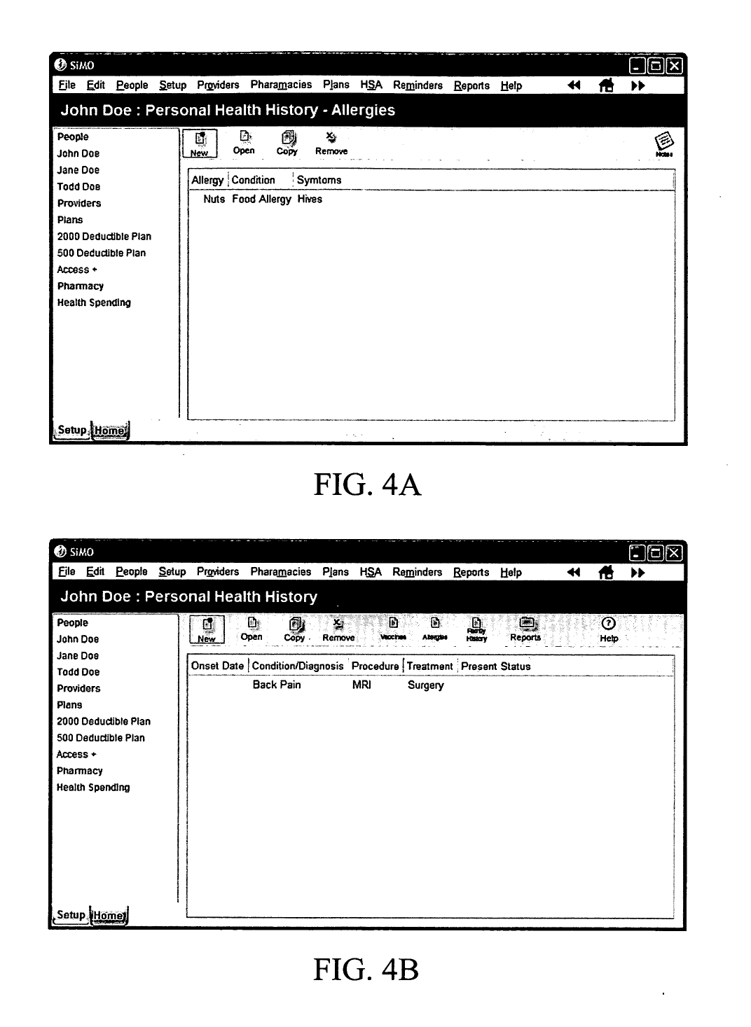

In a preferred embodiment, the software is capable of maintaining complete medical history information, including information about past medical events, conditions, medications, therapies, vaccinations, diseases, etc., which is continually updated, as described below, as further medical events are entered into the system and stored. Preferably, the medical history information may be updated by the user at any time, independently of any new medical events. FIG. 4A is a screen shot of an exemplary medical history form listing of allergies that have been entered into the system. Initially, this form is blank and specific allergies are added by clicking on the “New Allergy” button, or via a wizard. Similar forms are provided for other common conditions. Specific conditions which do not fall into a pre-established class may be added using the form, such as the one depicted in FIG. 4B. As seen, specific medical records or events may be linked to this form.

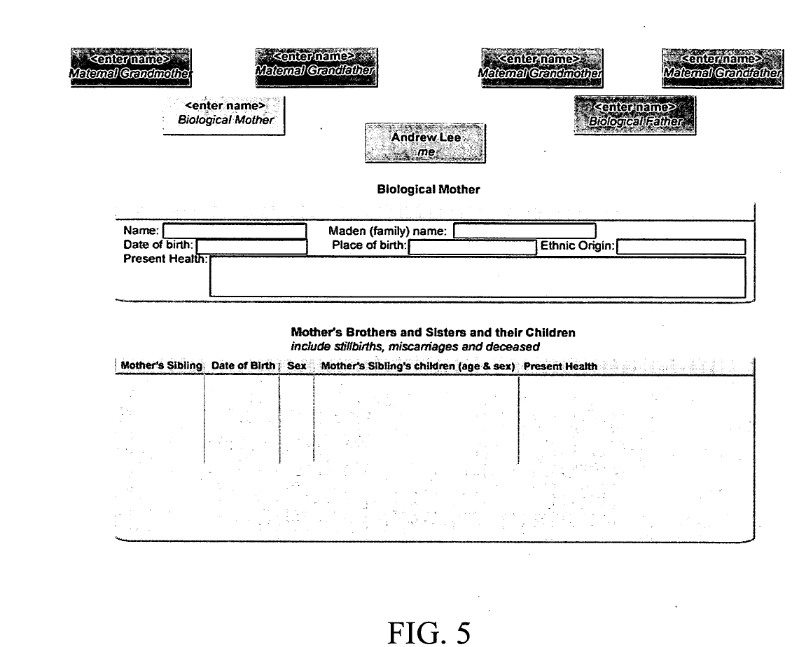

The medical history information preferably includes pertinent family medical history information, e.g., information about medical conditions of other family members which may be pertinent to the individual's medical profile. Where there are multiple related individuals entered in the system, the relationship information may be included in each individual's profile, and the pertinent medical history information may be appropriately linked. Thus, for example, if two individuals are related as father and son, heart disease information from the father's medical record may be linked automatically to the family history section of the son's medical history. Preferably, the links are intelligent, so that only those conditions, etc., for which family history is pertinent are linked. FIG. 5 is a screen shot of an exemplary form used to maintain family tree and related medical history information.

Preferably, the software of the present invention can create medical history reports that can be given to health care providers, as needed. Currently, health care providers generally require new patients to complete a comprehensive health care history form at the time of an initial visit. The software of the present invention allows the user to generate a comprehensive medical history report to give to the provider, thereby saving time and ensuring greater accuracy. Preferably, the medical history report can have user selectable components, so that the report can be reasonably tailored to the needs and requirements of the health care provider. Thus, for example, abbreviated versions of an individual's medical history may be sufficient for use by dentists, optometrists, physical therapists, etc.

Optionally, the software of the present invention can have pre-set medical history report formats which are useful in various different contexts. Thus, the software may have an optional medical history report specifically designed for new dental visits, providing the information typically collected by dental practitioners from new patients.

It is foreseeable that the health care industry will develop standardized medical history forms for general use or for use in connection with specific practice areas. Preferably, the software of the present invention is configurable to generate standardized reports, and to download report formats as they become available. It is also foreseeable that medical history information can be delivered to a health care provider online based on the medical history information maintained by the software of the present invention.

It is anticipated that health care providers will make medical history information available online to their patients for secure downloading. Such information may include text information, e.g., a medical specialist's report, and image information, e.g., a set of x-rays. It is foreseeable that such information will be made available in standardized formats. For example, text information may be made available in XML format (including its common derivatives, such as RTF and HTML), and image information may be made available in any standard digital image format including, for example, JPEG or TIFF format.

According to another aspect of the present invention, the software contains a subroutine for accessing, storing and maintaining medical history information that is made available online. Thus, for example, the software of the present invention may be used to download and store dental x-rays from a primary care dentist. This information can then be used, for example, by forwarding it electronically to an oral surgeon. In a further aspect the medical history information may have wizards and forms for periodically entering and/or downloading common standardized test and laboratory results such as weight, blood pressure readings, cholesterol levels, blood counts, etc. Preferably, the software of the present invention also has the ability to scan and store documents of any type, including documents that are related to medical history.

As part of the software set-up procedure, the user will also be prompted to use a subroutine to enter information about any available health benefit plans. Again, in the preferred embodiment of the software of the present invention, a wizard is available to guide the user through the process of entering plan information, or the wizard may be bypassed. While preferably any applicable plan information is entered during the set-up process, the information can be added, updated or modified at any time. It will be appreciated that many of the useful and novel features of the present invention may be realized even if the user does not have a medical benefit plan. Nonetheless, it is believed most users will have one or more potentially applicable medical benefit plans, as broadly defined above, and some of the key features of the software of the present invention pertain to tracking, coordinating and monitoring the benefits provided, or which are supposed to be provided, under such plans.

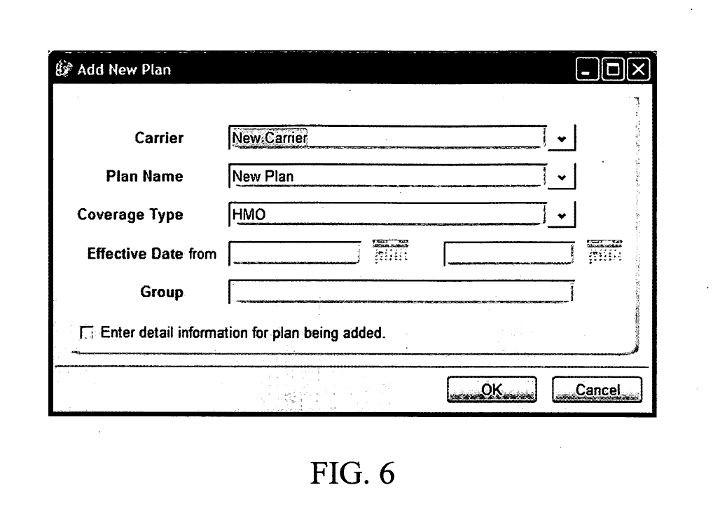

FIG. 6 is a screen shot of an initial form used to set up a plan. As seen the initial form contains basic information including the name of the carrier or insurer, the name of the plan and any related identifying information such as a plan number, the type of plan, etc. The user is initially prompted to choose from a list of plan types, such as HMO, PPO, major medical, dental, vision, health savings account, Medicare, etc. There are enough similarities in the benefits and rules associated with different plan types, such that identifying the type of plan may be useful in streamlining the process.

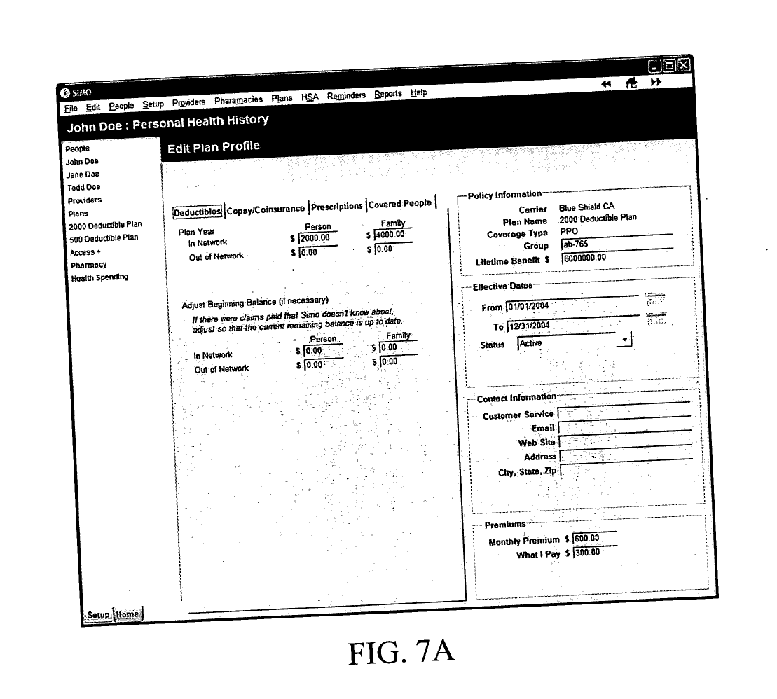

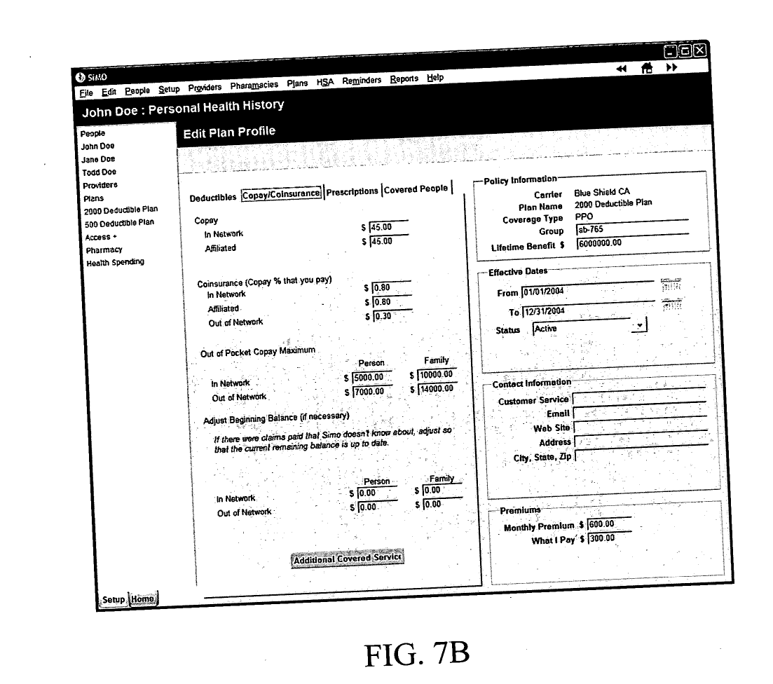

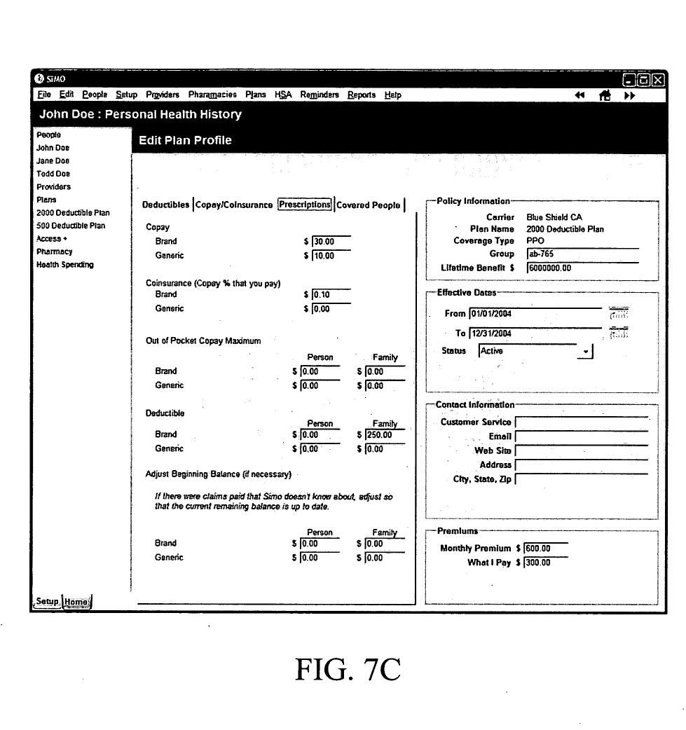

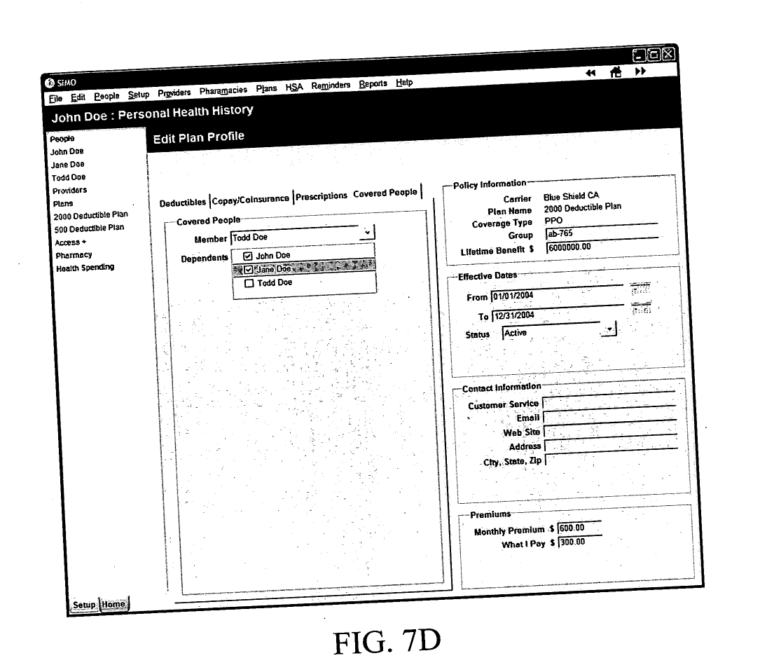

After the basic plan information is entered and a plan type is selected, one or more additional screens are presented to enable the user to enter the plan rules. For example, the plan set-up wizard may ask the user if the plan has deductibles and, if so, what they are. FIGS. 7A-7D are secondary forms used to enter additional plan information. Thus, FIGS. 7A-7D show screens which allow the user to enter additional plan profile information, as depicted, including, for example, the identity of the individuals covered by the plan, plan contact information, the term during which the plan is effective, premium amounts and payment schedules, and financial terms, such as co-pay amounts and deductibles and prescription drug benefits. Preferably, the secondary forms presented to the user are context-sensitive, such that different forms are presented depending on the type of plan selected when completing the form of FIG. 6. It will be appreciated that the nature of the benefits and rules for an HMO or PPO plan are considerably different than those of a prescription drug or vision plan.

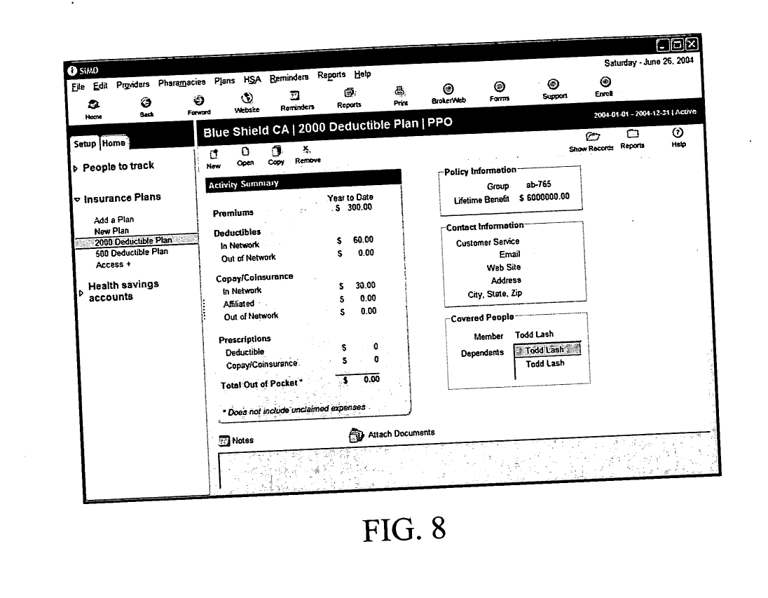

FIG. 8 is a screen shot of a plan summary window which is accessible to the user at any time after the plan has been set up. In addition to containing summary information about a plan, the window provides the user with recent plan activities, payments, and the like. This window is accessible by clicking on the plan name, as listed on the left column of the screen. Further by clicking on the icons just above the plan summary information, the user can review an existing record relating to the plan, can enter a new record or can copy a record for export from the program or for use as a template for creating a new, similar record. As also depicted in FIG. 8, notes may be added. Many of these same icons are available to the user from a variety of different windows or screens in the program.

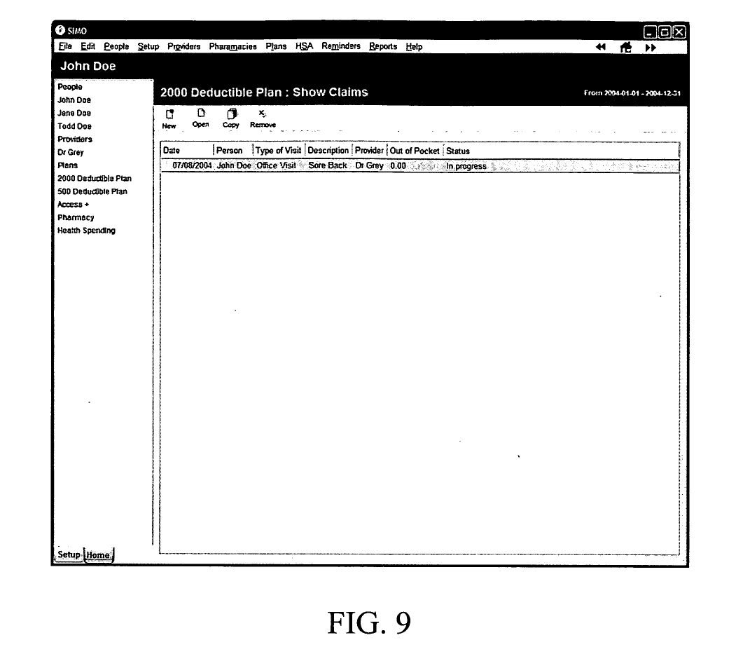

FIG. 9 is a screen shot of the medical events associated with a particular plan which is accessed, for example, by clicking on the “Show Records” icon shown in FIG. 8. Thus, the user can “drill down” from the general information displayed in FIG. 8 to a more detailed level. In addition, a complete record listed on the screen of FIG. 9 may be accessed by clicking on the record of interest.

Plan information can be divided into various categories, including contact information (e.g., the name, address, phone numbers, contact individuals, website and e-mail addresses, plan number or other descriptor, etc.) and plan rules. Plan rules may include, for example, financial rules pertaining to premiums, co-payment amounts, deductibles, out-of-pocket maximums, etc., and benefit rules pertaining to what medical events are covered by the plan, how the plan relates other plans, claim and appeal procedures, etc. Plan information may also include such items as lists of plan providers and forms approved by the plan to submit claims, file appeals, etc.

In order to facilitate access to the applicable plan information the software of the present invention preferably may be used to link the user, directly or indirectly, to one or more websites where such information is posted. It is foreseeable that plan information, of the type described, may be directly downloaded and stored by the software of the present invention. For example, it is anticipated that in some instances the software provider will work with plans to develop accurate downloadable plan information in a format that can be used by the software of the present invention. In addition, it is anticipated that in other instances the software provider will provide downloadable plan information based on publicly available plan information.

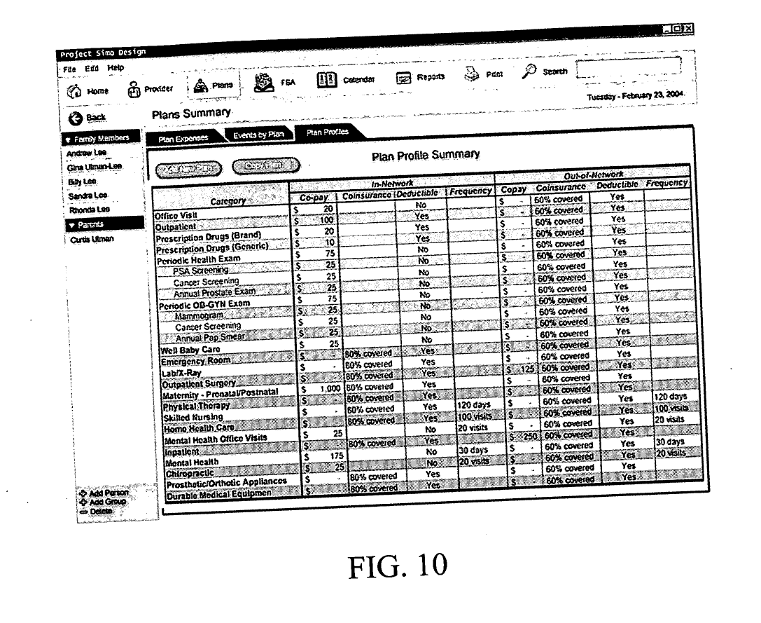

FIG. 10 is a screen shot of exemplary plan information downloaded from a website and entered directly into the software of the present invention. The various types of covered medical procedures are listed along with the benefits available for services from in-network and out-of-network providers.

It will be appreciated that many health benefit plans have complex rules, such that it may be overly cumbersome or impossible to accurately enter all of them. Thus, the software of the present invention enables the user to apply applicable rules on an ad hoc basis, as needed, in connection with specific medical events recorded by the software. In addition, the plan information can include exception information, for example, alerting the user that a particular medical procedure is excluded to limited in frequency. Generally, it will be advantageous to include at least certain basic plan information. For example, such information for a medical benefit plan would include basic deductibles, co-payment amounts, applicable percent of invoiced amount covered, etc. As another example, such information for a vision plan would include the extent, frequently and dollar limits on eyeglasses and contact lenses, any deductibles and co-payment amounts, etc.

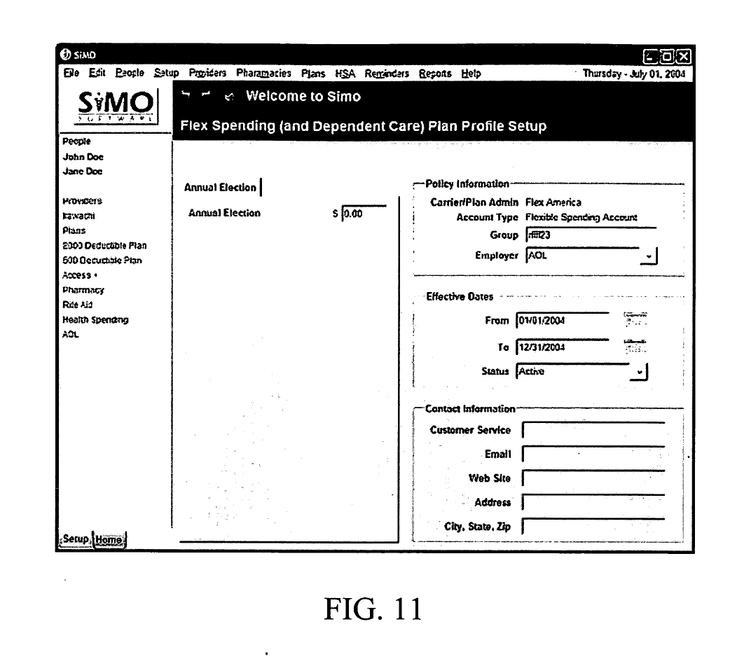

FIG. 11 is a screen shot of a form used to set up a flexible spending account. Such accounts typically have unique and relatively simple plan rules. In addition, by accessing the flex spending account screen after it is set up, the user is able to see all account activity and balances.

The software of the present invention also contemplates that the user will use a subroutine to enter and store health care “provider” information. This may be done in connection with the set-up process or at any time thereafter. Again, preferably, the information may be entered either using a software wizard or by completing forms presented on the display. As described above, the term “provider” is intended to cover all types of entities, both individuals and institutions, which provide health care related products or services, such as doctors, dentists, psychiatrists, optometrists, opticians, chiropractors, acupuncturists, physical therapists, podiatrists, pharmacists, clinics, medical groups, hospitals, laboratories, etc. The provider information includes contact information, e.g., name, address, phone number, etc., rule information, e.g., billing procedures (i.e., bills plan directly), and plan associations. According to the present invention, providers may also be linked. For example, a physician may be linked to one or more institutions, such as hospitals and clinics, which are separately entered as providers. While it is up to the user to decide which providers to enter, preferably, at least the providers that have direct financial relationships with either the user or one of the plans, are entered so that the benefit reconciliation features of the present invention, as described below, are fully realized.

When entering a new provider, the software of the present invention may prompt the user to choose from a list of provider types. In this way, the unique qualities of different classes of providers may be addressed.

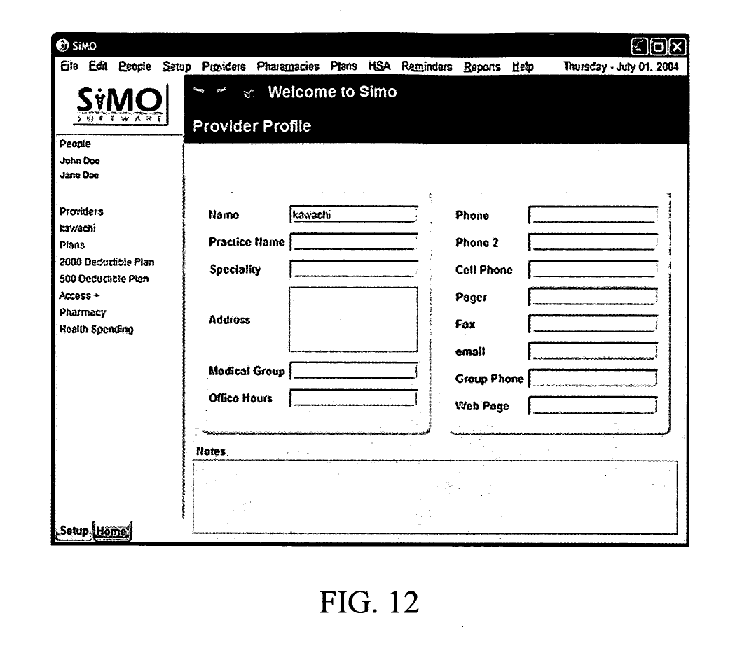

FIG. 12 is a screen shot of the initial form which may be used to set up a new provider. Note that various providers may be linked with a practice group. In such a case, both the group and the individual practitioner may be considered to be “providers,” as used herein.

According to the preferred embodiment of the present invention pharmacies are one type of provider which are treated as a special class. Thus, when a pharmacy is first entered into the system as a provider, in addition to the normal contact information, the user is able run a subroutine to enter and store data about prescriptions maintained by the pharmacy, including, for example, medicine name and type (e.g., generic/non-generic), dosage, refill and prescriber information. This information may be linked to medical history information. Thereafter, as new medicines are prescribed, the pertinent data may be entered as a medical event, as described below. Preferably, the software of the present invention contains a list of reminders or calendar, as described below, and prescription information (such as refill dates and refill expirations) are entered into the system and appear on the list or calendar. In addition to prescriptions, the software of the present invention allows users to keep track of non-prescription (i.e., “over-the-counter”) medications and, if desired, supplements, vitamins, etc.

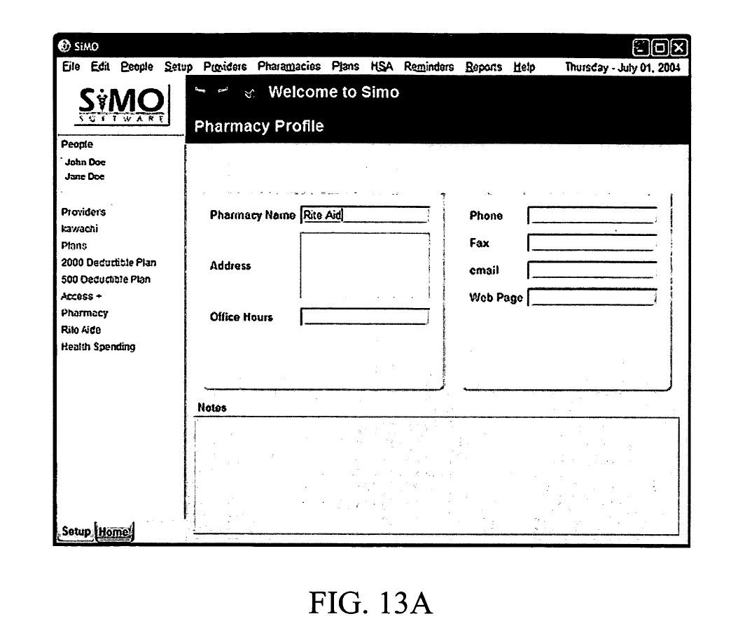

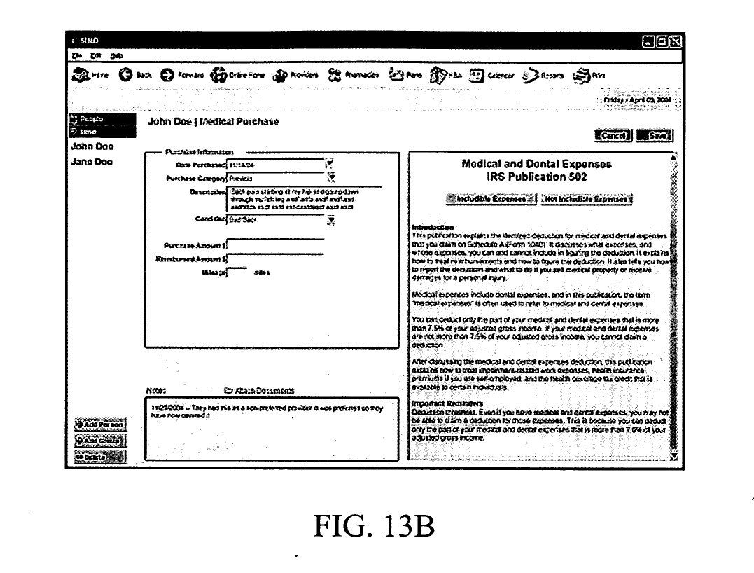

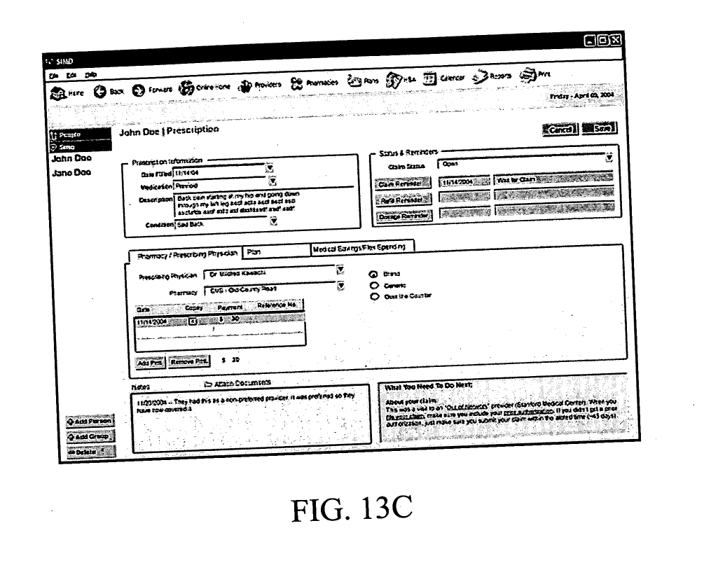

FIGS. 13A-13C are screen shots of forms used to set up a pharmacy and to enter prescriptions into the system. Note that purchase and tax-related information can be entered on the prescription forms and the prescription can be linked to a condition. In addition, as with most of the forms used with the software of the present invention, a field is provided for entry of notes. Additional fields are provided to enter refill information and reminder schedules, etc., as depicted.

In another aspect of the present invention, the software is capable of linking directly to a pharmacy's website or other computer system, for various purposes, including, for example, to request prescription refills, to verify benefit information and calculations, and to identify which plans are handled by the pharmacy and, possibly, to obtain information about available discount plans and about specific medicines.

In a further aspect the software of the present invention the software is able to identify drug information, either by maintaining a locally-stored, updateable database, or by linking to database maintained remotely, such as on a website maintained by the software provider or a pharmacy. Such a database may be used to verify that the dosage amounts are within the correct parameters, to identify known side effects, and to provide general instructions associated with use of the medicine (i.e., take within an hour of eating). While much of this information should be furnished by the doctor and the pharmacist, it is useful to have the information readily available for verification and reference purposes. In addition, the database may provide comparative pricing information about medicines. The comparative pricing information may include, for example, information concerning the prices charged at various pharmacies, any discounts available using various types of discount cards, and the price difference between generic versus non-generic versions of a medicine.

Forward looking cost estimates can be created based on medicines that are taken continuously. Users may have choices concerning how to purchase medicines. In some instances, the best benefit or discount card to use will depend on the total expenditures, and the software can assist in making this determination. For example, the newly enacted Medicare prescription benefit program allows users to obtain discount cards from health care providers and further provides benefits which vary significantly depending on the overall amount that the user has spent for medicines in the current year. Currently, individuals are only allowed to have one Medicare discount card, but the benefits available under the different cards may be much different depending on the card provider. The software of the present invention enables the user to compare the benefits and out-of-pocket expenses associated with different Medicare discount cards based on their specific needs, i.e., based on the specific medicines they require. In another aspect of the present invention the software provider will maintain comparative discount information on its website.

Often the user will have different discount cards from different providers which offer different benefits. Thus, a user may have a Medicare card and one or more additional cards from other sources, such a pharmacy or an organization such as AARP. In one aspect, the present invention enables the user to determine which approach is most economical (e.g., which discount card to use) given the various benefits available under the any applicable plans by running comparative calculations. It is noted that the current, recently promulgated Medicare discount card system is scheduled to be revamped by the year 2006, and that the details of the new system that will replace it have not been announced.

The software of the present invention has a subroutine comprising a wizard and one or more forms for entering medical events, thereby generating a medical record of a transaction. According to the present invention different forms may be used for different types of medical events, or a wizard is used to guide the user through the process of creating a new medical event, proceeding along a decision tree which is context sensitive. In each instance the medical event form will include the identity of the individual, the identity of the provider, and information about the nature of the event—e.g., visit to optometrist for eye examination, arthroscopic surgery on a knee, physical therapy. If the individual or provider has not previously been stored in memory, the user will be prompted to complete the appropriate form or wizard for setting up the individual/provider. The medical event form or record will also include fields for entering the available information about amounts paid and billed by the provider. Thus, there are preferably fields for co-pay amount, amount paid by the individual at the time of the medical event, the amount billed to the primary plan, the amount billed to the individual, and the amount of any claims submitted to secondary plans. Needless to say, it may not be possible to complete many of these fields contemporaneously with the medical event.

An exemplary medical event or medical record wizard for a office visit to a doctor might proceed by asking the user, in sequence, to identify the individual, the purpose of the visit, the name of the provider, a description of the event, the identity of any applicable plans, and any payments made (i.e., a flat co-pay, the full doctor's charge, etc.). If there is an applicable plan, the user will then be asked whether a claim has been or will be submitted. Next the user is asked whether the individual who received services has responsibility for making further payments and, if so, when payment will be made (e.g., immediately, after receipt of invoice, after processing by plan, etc.).

In some instances, responses to questions posed by a wizard can be selected from a pull-down or other type of menu. For example, the identity of the individual, provider or plan may be selected from lists that have already been stored by the program in memory. As noted, if person, provider or plan is not already listed, the user will be prompted to create a new individual/plan/provider entry.

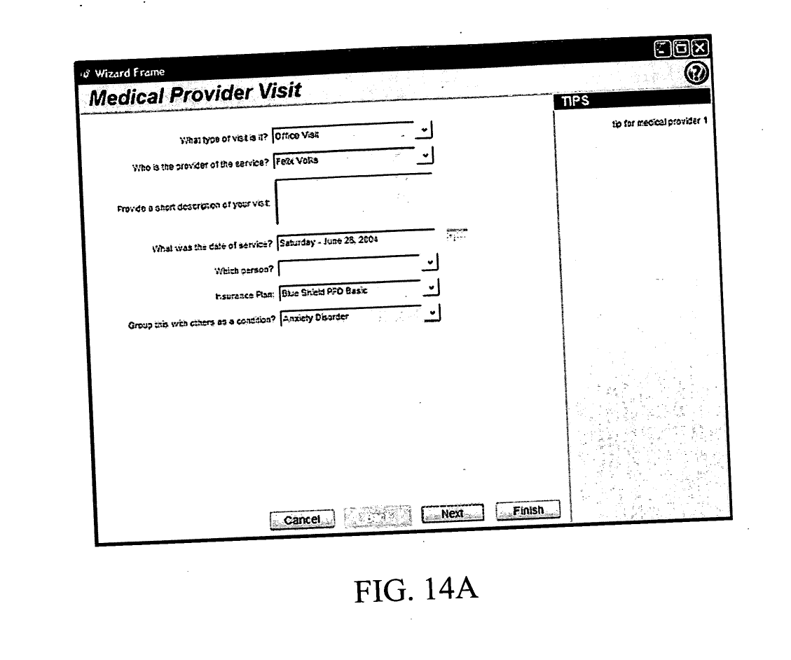

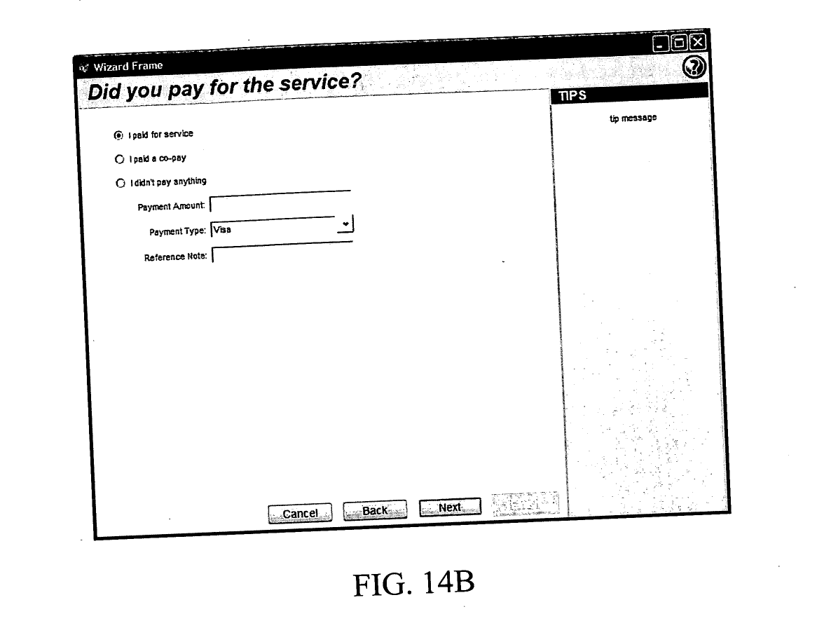

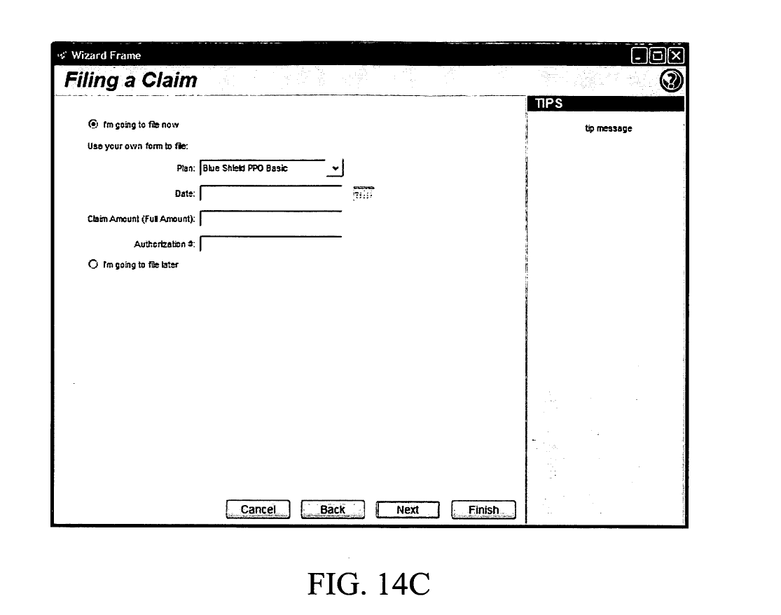

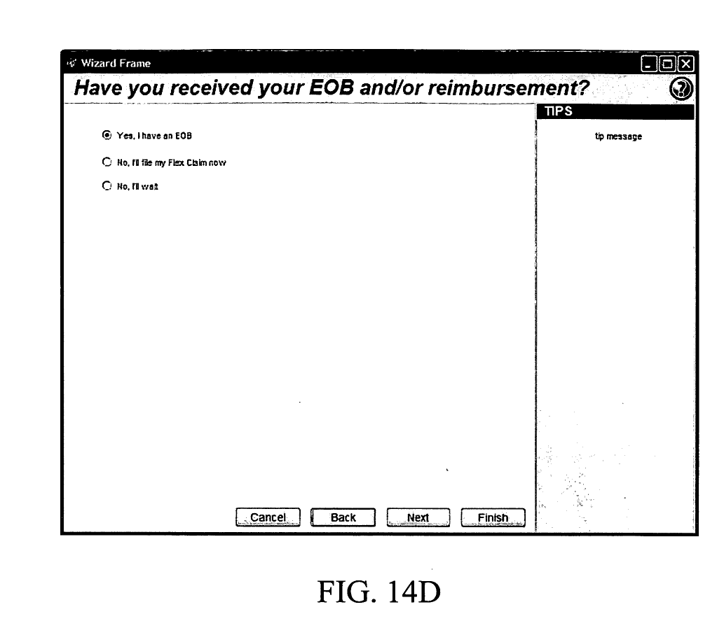

FIGS. 14A-14D are sequential screen shots depicting a exemplary wizard for a medical provider visit, including basic information about the visit (FIG. 14A), information about any payments made (FIG. 14B), whether a claim will be filed (FIG. 14C), and whether any reimbursement or explanation of benefits has been received (FIG. 14D). Note that each of the wizard screens may provide context sensitive help.

An exemplary wizard for filling a prescription may proceed by asking, in sequence, the name of the medication, the name of the pharmacy provider, the individual for whom the medicine was prescribed, the prescribing doctor, the amount received, the date the prescription was filled, the number of refills, the expiration date of the medicine, a description of the purpose of the medication (e.g., cough medicine), instructions for taking the medicine, etc. In addition, the wizard asks about financial and claims information as described above (e.g., was a co-payment made, does a plan cover any portion of the amount, will a claim be filed, does the amount paid go towards a plan deductible, etc.). As described below, the user may also be asked if the user wants to add tickler information to the calendar or to a reminder list to alert the user of refill dates or refill windows. Some plans limit the time in which a refill may be obtained.

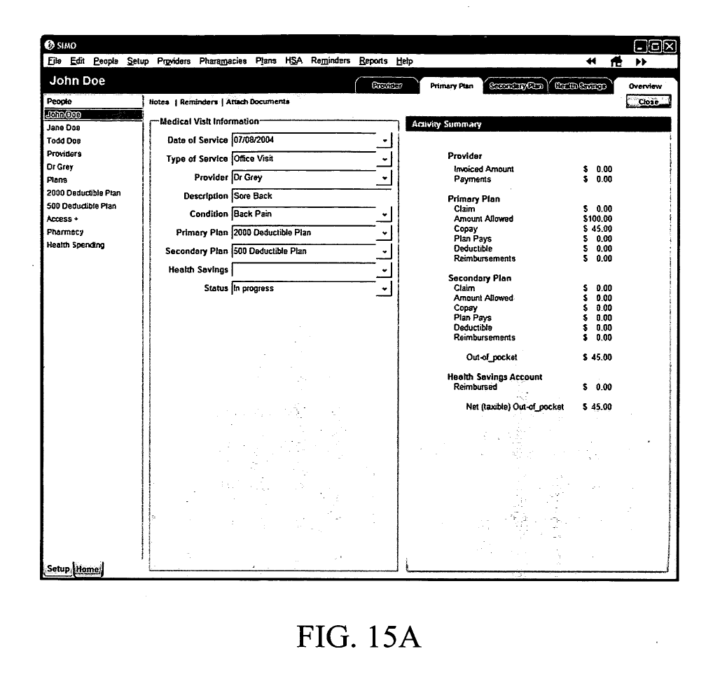

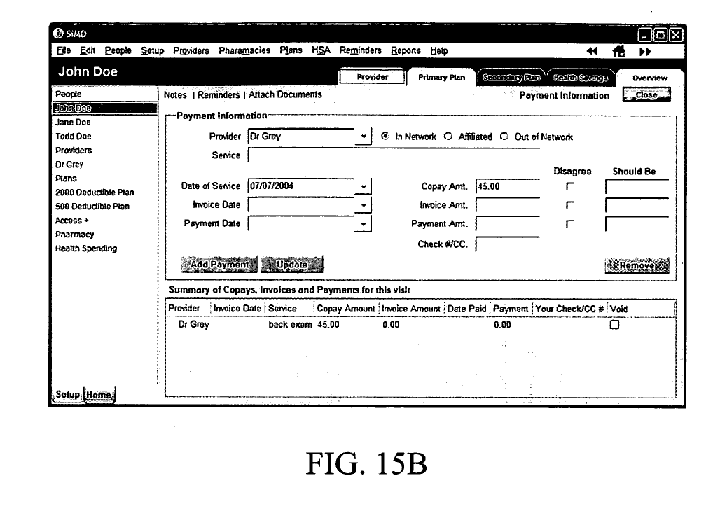

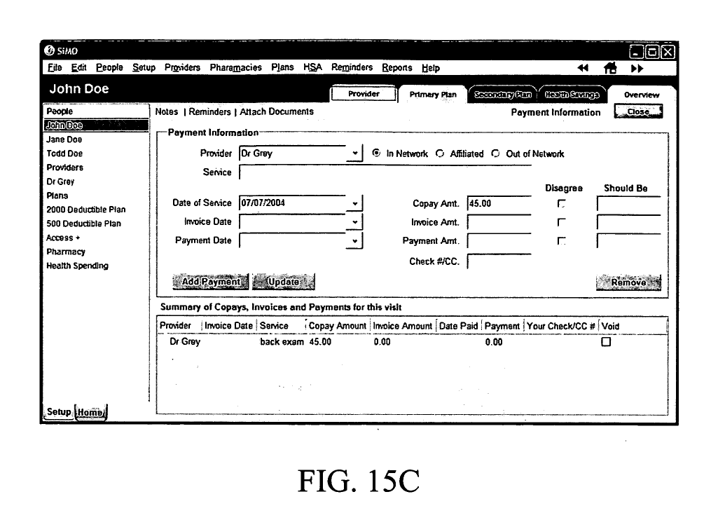

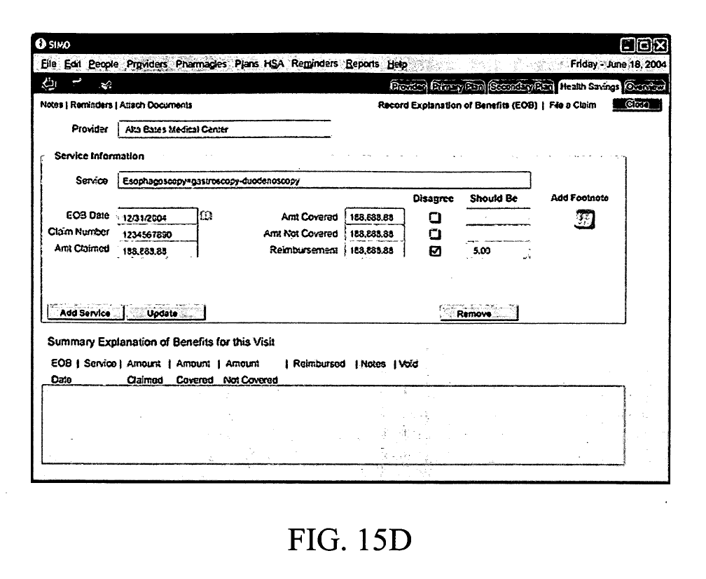

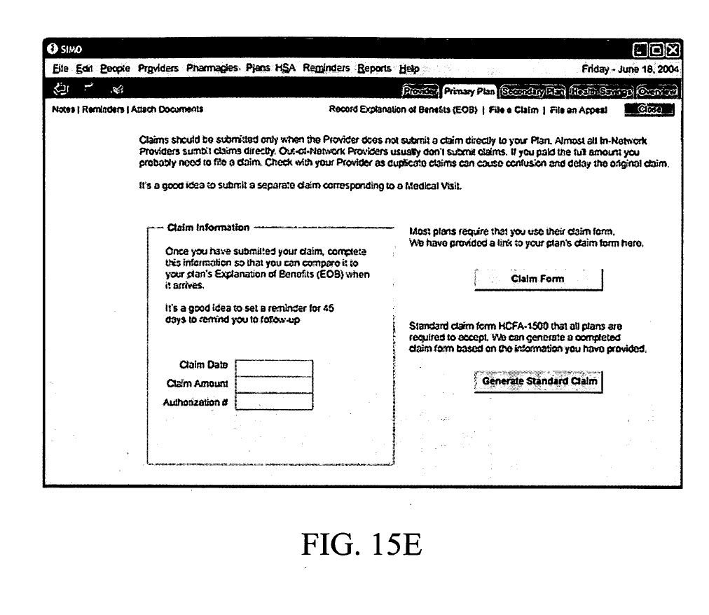

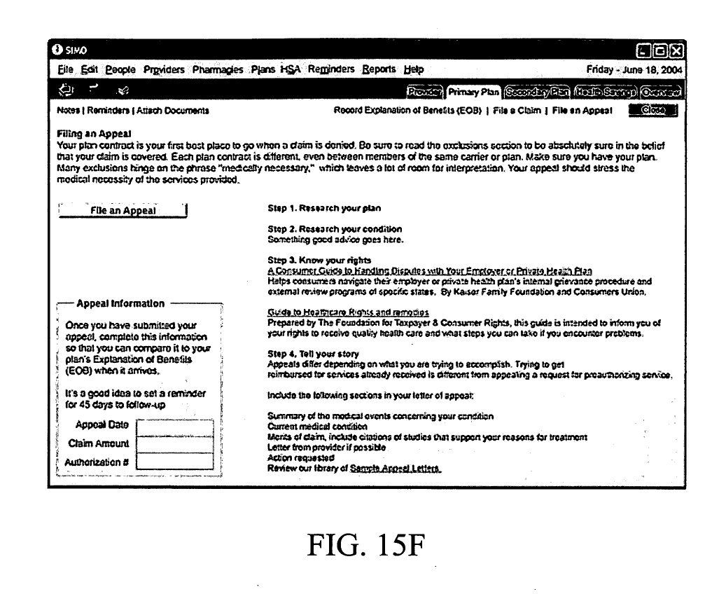

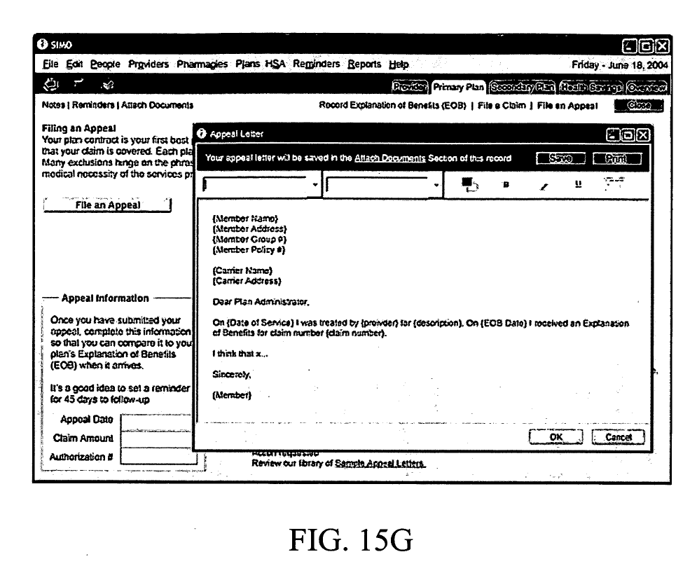

Rather than use a wizard, the user may simply enter information concerning a medical event in a form or series of forms. Such forms may be completed, edited and updated, as necessary, for example, as a related claim is processed. FIGS. 15A-15G are screen shots of the various information windows that may be associated with a medical record of the software of the present invention. Each of these windows may be used to display, enter and store information relating to the record. It will be appreciated that not every record will have each of these screens. For example, FIGS. 15E-15G are related to claims and appeals. These screens are not created by the software for a particular record until a determination is made to file a claim and/or appeal. Moreover, the nature of the specific screens associated with a medical event will depend on the nature of the event.

Preferably, some or all of the information relating to a medical event may be obtained online, to avoid the need to enter it manually.

As noted, according to the present invention, medical events may be linked together as a group. For present purposes each such grouping is referred to as a “condition”. Thus, if an individual suffers a broken leg, the various medical events or records, comprising, for example, an emergency room visit, an initial doctor's charge for setting the bone and making a cast, a laboratory charge for x-rays, the purchase of medical appliances (e.g., crutches) and medicines, and charges for follow-up doctor's visits and x-rays, can all be grouped together. In this way the user is able to track the medical and financial aspects of a particular condition over time. As one example, such information may be important in connection with filing a claim against a third party, for example, if the exemplary broken leg were caused by an automobile accident covered by a third party's auto insurance.

In defining a condition, the user is given the choice of selecting from a list of predefined conditions or creating a new condition. Predefined conditions may include, for example, “diabetes” and “high blood pressure”.

A core feature of the present invention is its ability to track and reconcile the processing of claims associated with medical events. Claims processing is handled differently by different types of plans and, preferably, the software is adapted to handle each of the various methods. Normally, payment is made in one of the following ways: (1) The individual pays the entire amount at the time the service is provided, and then submits a claim to one or more potentially applicable health benefit plans. Where there is more than one applicable plan, it is usually necessary to wait until the claim is processed by the primary plan before submitting a claim to a secondary plan, however, in some cases the provider will handle the “coordination of benefits” where more than one plan is applicable. (2) The provider bills the plan directly and, after being paid (or if payment is denied), subsequently bills the individual for any amount not covered by the plan. After the primary plan makes payment to the provider, the individual may then submit a claim for some or all of the amount to a secondary plan, or may decide to challenge the primary plan's payment decision. Normally, the individual pays the provider directly for any amount not covered by the primary plan, which may include a percentage co-pay. (3) The provider bills the primary plan directly, and obtains the amount not covered by the plan, such as a deductible or a percentage co-pay, from the individual at the time of the medical event. The individual may then file a claim with a secondary plan for some or all of the amount paid directly to the provider. In this situation, the provider typically estimates the amount that will be paid by the plan, and often these estimates are wrong. If the provider's estimate is wrong, it may result in some of the amount paid by the individual should be refunded, or it may result in an additional bill from the provider to the individual seeking any deficiency. In either case, it may be necessary to adjust any claim sent to the secondary plan. In addition, there may be a flex benefit plan which covers some or all of the amount not paid by the primary or secondary plans. Typically, it is necessary to resolve everything with the primary and secondary plans before seeking reimbursement from a flex plan. (4) The provider collects a flat co-pay amount at the time of the medical event (e.g., an office visit) with the expectation that the individual will have no other financial responsibility. This is typical with certain HMO's. In this situation, any billing or other financial transaction between the provider and the plan relating to the medical event will generally not become known to the individual. The individual may be able to submit a claim for reimbursement of the co-pay amount to a secondary plan. In some cases, coverage is denied by the health plan and the provider then bills the individual for the services. (5) Additionally, there can be medical events for which the individual has no financial responsibility, and remains completely unaware of how the provider gets paid. This is the case with certain HMO plans, and with medical services provided by third parties, such as where the individual's employer provides certain services or where the individual is a participant in a medical research program. The windows of FIGS. 15A-15G are adapted to permit the user to handle these different scenarios.

Often, a provider will send an individual who received services a notice of the amount billed to the applicable health plan, with an indication that the individual is responsible if the health plan doesn't pay. It the health plan does not make timely payment or disputes an amount, the provider may then send the individual an invoice. The software of the present invention helps the user track these notices, and any subsequent invoices, so that the user can take appropriate follow-up action. For example, the user might wish to contact the health plan to understand why payment has been delayed or is being disputed.

According to an aspect of the present invention, if the financial aspects of a medical event are not fully resolved, the medical record is marked “open” and the user will automatically be reminded of that fact. Open records may be further subcategorized and displayed in sorted fashion; for example, depending on the processing status—“file claim”, “waiting for explanation of benefits”, “on appeal”, etc. Automatic reminders can be periodic (e.g., a list of open items can be reported to the user on a monthly basis), or aperiodic (e.g., a list of open items can be presented each time the user launches the program). The automatic reminders may be limited to only those which meet certain conditions (e.g., open more than thirty days). In addition, the software allows the user to display the open items on demand, and to display all them, or a subset of them, sorted or filtered on various fields. Thus, the user may query the software to list all open items for a particular provider that are over sixty days old, or the open items under a particular plan. The information in a medical record may be updated or modified as the related financial events occur with the record remaining open until the entire transaction has been completed. As shown in FIG. 1, preferably the software may be configured to display a list of “open” items on the initial or home page.

When a provider bills a plan, or when a covered individual submits a claim to a plan, it is customary for the individual to receive an “explanation of benefits” form (“EOB”) from the plan describing the action taken. Traditionally, the plan mails a copy of the EOB to the individual covered by the plan after it has processed a claim submitted by either the provider or by the individual. The present invention contemplates that EOB information may be provided by plans in electronic form, such as by being e-mailed or made available for downloading from a website or other computer network. Preferably, the provider of the software of the present invention will work with plans to develop electronic EOB formatting which can be directly processed and used by the software. Moreover, the software will preferably be adapted to contain a subroutine which can use any industry standard formatting hereafter developed. Information from the EOB is preferably entered into the record of the related medical event(s). The core EOB information entered into the medical event record may include the name of the plan which sent the EOB, a claim number, the date, the amount billed, the amount allowed, the amount paid, the amount applied to a co-pay, the amount applied to a plan deductible, the amount not paid and the amount of the individual's responsibility. Typically, an EOB will be sent whether the claim is submitted by the provider or by the covered individual seeking reimbursement. Where the claim is submitted by the individual, the EOB may be accompanied by a payment. The software of the present invention assists the user by verifying the calculations contained on the EOB, either automatically, if possible, or by using a wizard with analyzes the EOB on a step-by-step basis, asking the user to enter any information which is unknown to the software—for example, the percentage co-pay for a particular type of procedure that is not contained in the plan rules stored by the software.

Since there may be multiple plans which provide coverage of a medical event, there may be multiple EOB's associated with the medical event. Preferably, the corresponding medical record maintained by the software of the present invention is able to accept information about multiple EOB's, and the reconciliation processes described below may be repeated for each of them.

The EOB normally indicates the plans' determination of the extent of its financial responsibility for the medical event, and normally also indicates the extent of the individual's personal responsibility. Thus, an EOB may indicate that it paid a dentist $100 for a dental examination and x-rays, and that the individual is responsible for $75. The EOB will normally indicate the reasons for these determinations. Thus, in the example given, the EOB may say that the individual's share of $75 comprises $25 for the remaining balance of the annual deductible and $50 for individual's share of the dentist's examination fee. It is noted that some providers are required to agree, as a condition for participating in a plan, to limit their charges for certain services to allowable amounts. Thus, in the example given the EOB may advise the individual that his or her responsibility for the dental examination is limited to $50 notwithstanding the fact that the amount billed by the dentist exceeds this amount.

As described, a medical event or record may include a number of different services rendered by the provider. Often the various different services associated with an event are listed on different EOB's and reconciliation may be further complicated by the fact that multiple EOB's are received from multiple plans. As part of the reconciliation process, the software of the present invention assists the user in associating services listed on multiple EOB with the correct medical record, thereby minimizing the chances for errors. Similarly, the software of the present invention assists the user in associating multiple entries on a single EOB with the correct medical events and conditions.

According to the preferred embodiment of the present invention, when the EOB is received, the software may be used to automatically attempt to reconcile the transaction using the plan rules entered into the system, the data entered at the time of the medical event, the data on the EOB and other data stored by the software. Thus, in performing this reconciliation, the software will also consider other medical events that have been recorded in the system, for example, to determine whether the individual has previously entered medical events which should be counted towards the plan deductible, or to determine whether the individual has had dental x-rays taken within the allowable plan time. In some cases, the benefits available under a health benefit plan are limited by the amount which is considered by the plan to be “reasonable and customary” for the particular service or medical event. In one embodiment of the present invention, the software maintains an updateable database of information useful for determining what is the reasonable and customary charge for a particular medical procedure. Such information can be derived from publicly available sources, from health benefit providers and from plans.

It is noted that there is a system for categorizing specific medical procedures according to classification codes. In one aspect, the present invention maintains a database of accepted industry codes and allows users to enter the specific codes associated with medical events.

As noted, the software of the present invention preferably has the capability of scanning and storing documents. In some instances, the user may wish to scan EOB forms, and other documents related to a medical event, so that they can be available for use in connection with claims, appeals, etc.

The attempted reconciliation may have multiple outcomes. The EOB information may match the information already associated with the related medical event in which case the transaction is reconciled and the medical record may be closed. According to the present invention, closure of a properly reconciled medical event can be automatic, or the program may prompt the user to verify the closure. Which approach the program uses may be user selectable during the above-described program set-up process. In any event, the program preferably allows the user to “open” a previously closed transaction, for example, if the plan sends the user a modified EOB.

Where the EOB information is properly reconciled, i.e., the EOB explanation agrees with the information in the medical record and plan rules stored in memory, this may not be the end of the matter, since the receipt of the EOB may trigger the ability of the user to submit a claim to a secondary plan. In such a case, the software prompts the user to submit a claim and, preferably, is able to generate a hardcopy or electronic claim form for submission to the secondary plan. However, the user may defer submission of a claim. For example, where the secondary plan is a flex-benefit plan which covers a multiplicity of different types of medical events, many users find it most convenient to submit claims covering multiple events, rather than submitting a separate claim for each item. In all such cases, the software keeps the underlying medical event records “open” until processing of the secondary claim is complete.

Another possible outcome of the automatic reconciliation process is that the software is unable to evaluate whether the EOB is correct without entry of further information. As described, in many, if not most, instances, the plan information and prior medical event information entered into the system will be incomplete such that the necessary information is not in the system. Thus, for example, the EOB may say that the charge for dental x-rays was denied because the plan only pays for one set of dental x-rays per year, and the required time had not yet elapsed. In such a case, it is possible that the pertinent plan rule had not been entered into the system, or that the earlier dental x-rays had not been entered as a medical event. In such a case, the user may be required to manually enter additional plan information or additional medical events, such as events which predate installation of the software. As noted the software provides links and other means for the user to look up or otherwise determine applicable plan rules.

Preferably, the software contains a wizard which leads the user through the reconciliation process. However, at any time in the reconciliation process, the user may simply decide to accept that the EOB accurately reflects the amount due under the plan and close the record or proceed to the next step, for example, submit a claim to a flex-benefit plan.

The automated reconciliation process of the present invention may determine that the EOB is incorrect. Health benefit plans frequently make errors in their benefit determinations, and the reconciliation process of the present invention is intended to assist the user in uncovering such errors. When an EOB error is uncovered, the related medical record is kept open and the user is, preferably, prompted to take follow-up action. Such action may range from making a telephone or e-mail inquiry to filing a formal appeal. As described the software of the present invention is designed to assist the user in taking follow-up actions in a variety of ways, such as describing the applicable plan rules for correcting an erroneous EOB (i.e., describing any applicable appeal period and rules), providing contact information and links, including, for example, e-mail addresses and telephone numbers for informal inquiries, and providing both plan-specific and model forms for formal inquiries and appeals.

One of the most common reasons that claims are denied by health benefit plans is the because the claim purportedly contained incomplete or insufficient information. When faced with such a denial, many individuals do not bother to collect the information necessary to resubmit the claim and, therefore, do not realize the benefit to which they are entitled. The present invention facilitates the resubmission of such claims by making all of the pertinent information easily accessible to the user, and by providing the user with forms, model letters, etc. to resubmit the claim.

Based on the medical records, as described, the software of the present invention is able to generate summary lists and reports of claims in various groupings, for example, closed (i.e., reconciled), pending and disputed. Such a listing may be displayed by selecting the appropriate software menu item.

The software of the present invention keeps a ledger of all of the financial data entered into the system. Preferably, this ledger can be directly viewed by the user, can be sorted on various fields, filtered to provide only desired information and used to generate reports in preset or user-defined formats. Thus, the user may view the ledger to see all transactions, only those transactions related to a particular plan, only those transactions associated with a related set of medical events, or only those transactions for a particular provider, etc. In addition, the ledger is, preferably able to “void” transactions while maintaining a record of them. This is useful, for example, when an amended EOB is received, permitting the user to keep a history of a transaction.

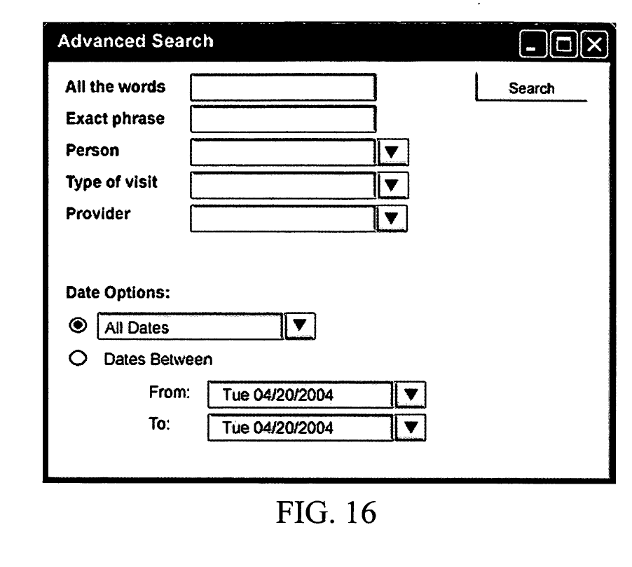

FIG. 16 is a screen shot of an advanced search inquiry window which may be used to find a specific record or a grouping of records meeting certain criteria. As depicted, the software of the present invention allows the user to search using various parameters and ranges.

The software of the present invention preferably contains an interactive calendar or reminder list which may be viewed by the user on demand. According to one embodiment, the user set-up routine allows the user to specify that the calendar or reminder list should appear each time the program is launched. Alternatively, the program may simply provide a listing of events which are scheduled within a user-selectable time period (i.e., 30, 60 or 90 days). When a follow-up action is taken by the user, the software keeps the record open and preferably enters reminder information on the calendar. Unless deactivated by the user, the software automatically enters a calendar item for all open medical events. The tickler information is intended to alert the user of any specific due dates, and to remind the user of open items to check the status and take follow-up action. Likewise, tickler information may be used to schedule payments due to providers. For example, a user may make an informal inquiry concerning an EOB, but may also have a specific time to file an appeal under the plan rules. In such a case the appeal deadline will be entered on the calendar and, in addition, an earlier reminder may be calendared for further follow-up on the informal inquiry. In addition, government regulations and plan rules may require that the plan respond to an appeal or other inquiry within a set time frame, and such dates will also be entered on the calendar. Likewise, when a medical event is first entered into the system, a tickler may be entered on the calendar setting a date for possible follow-up if an EOB has not been received. Preferably, the software contains a database of sample letters for making inquiries and, if necessary, filing appeals. Such sample letters may be used if specific plan forms are not otherwise available. In addition, links to resources which may be useful in connection with the appeal process may be provided.

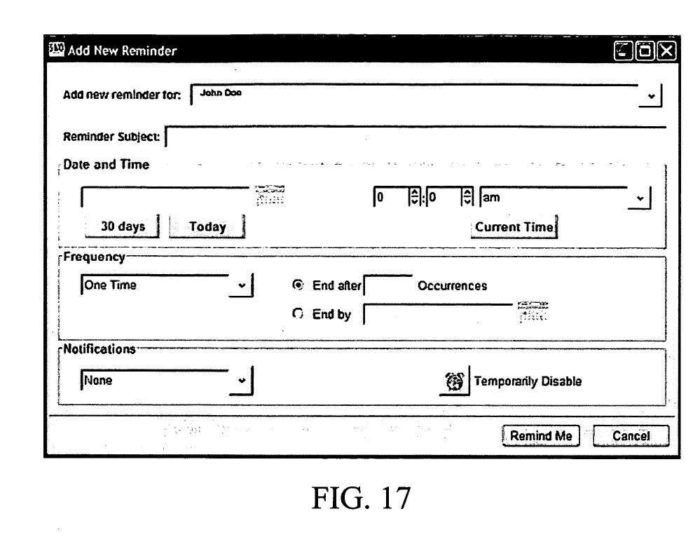

Preferably, the scheduling of non-recurring and recurring events may be entered into the calendar by completing single form. FIG. 17 is a screen shot of a window which may be used, according to the present invention, for entering reminders, for example, an upcoming doctor's visit, weekly visits to a physical therapist, monthly prescription refills, semi-annual dental examinations. Thus, the calendar or reminder list may also be used to remind the user to refill prescriptions, to remind the user of medical appointments, to submit claims, etc.

Preferably, the software of the present invention is configured to provide alerts of calendared items a predetermined amount of time prior to the date. Such alerts may be provided in a variety of ways, including, for example, via “pop-up” windows, alert boxes, etc. The software may be configured to automatically send a reminder e-mails (for example, to a mobile phone, a PDA or a work e-mail address). Preferably, the user can set the timing of any such alerts and can separately specify the type of alert (if any) associated with various calendared items or classes of items. In addition, in embodiments where some or all of the software is operated on a remote server, alerts can be transmitted by e-mail or other means, even if the user's personal computer is not running.

The plan information stored in memory may be useful to advise or alert users concerning the scheduling of medical services. For example, if a dental plan covers teeth cleaning no more than once every six months, the software of the present invention can be used to alert or advise the user concerning the scheduling of an oral hygiene appointment.

Many individuals have flexible benefit or cafeteria plans which may be used to cover out-of-pocket expenses that are not covered by other plans. Such plans usually provide a maximum annual benefit on a “use-it-or-lose-it” basis. In order to realize the full benefit of such a plan it is useful to track the plan balance and to the timing of certain reimbursable expenditures, particularly those which are not otherwise covered. Thus, if it is likely that the flexible benefit plan will have an unused balance at the end of the year, the individual might wish to purchase eyeglasses or have an optional dental procedure performed in order to take advantage of the unused balance. However, if the covered individual waits to the last minute, he or she may not be able to schedule the necessary appointment or receive an invoice in time for submission to the plan. In accordance with another aspect of the present invention, the software sends the user reminders of the status (e.g., balance) of any applicable flexible benefit plans so that the user can make health care related purchase decisions with a view towards maximizing benefits. The frequency of such reminders can vary according to the time of year. Thus, at the beginning of an annual flexible benefit plan period, the reminders may be infrequent, with the frequency increasing towards the end of the year.

As described, the software of the present invention keeps a ledger of all health care related expenses. This ledger may also be used to generate tax information. Preferably, the software of the present invention is able to calculate and print medical expense deduction forms which may be directly submitted to federal, state and local tax authorities.

The financial information stored in computer memory by the software of the present invention may also be used for planning purposes. For example, as discussed, individuals are frequently faced with the need to choose between multiple health plans, such as when starting a new job or during an open enrollment period. While there are many subjective and other non-economic factors that an individual may consider when faced with such a decision, the overall economic impact is usually important if not paramount. Various options available to the individual may have very different economic impacts depending on the user's specific needs. For example, under some plans the user's share of the plan premium's will be very low, but the available benefits may also be low. This type of plan might be best for someone who is relatively healthy and who does not expect to have major health expenses in the upcoming plan period. On the other hand, someone with significant anticipated health care needs may be better off paying higher premiums for a plan that provides greater coverage. Further, in making this economic judgment, the user will want to take into consideration secondary plans that may also available to provide benefits. Thus, for example, in comparing plans available to him, a husband may wish to take into account the benefits available under his wife's plan.

According to an aspect of the present invention, the user may use a subroutine to generate comparative economic scenarios to assess the potential total anticipated out-of-pocket expenses under different plan choices available to them. Preferably, in running such scenarios, the software takes into account all available plans, including those which may not be changed (e.g., a spouse's plan or a flexible benefit plan that is available regardless of what primary plan is selected). Such scenarios may be based on historical patterns of usage, may be based on anticipated usage, or on some combination of the two. The software of the present invention preferably provides planning and modeling tools for these purposes. Specifically, the software can calculate how the medical events of a prior year (or some other specified period) would have been treated under the rules of various plans. In generating these estimates based on historical data, the subroutine can, preferably, filter out any medical events associated with a significant non-recurring medical condition. Thus, the user can instruct the software to create a scenario based on last year's data, but without taking into account the broken leg.

Likewise, the software can calculate how different anticipated medical events would be treated under different plans. It should be understood that the calculations may not be perfectly precise, particularly in view of the complexity of plan rules. However, even a rough comparison will often be useful for planning purposes. Of course, the calculations will not only include the individual's financial share of specific medical events, but will add in the individual's share of plan premiums, etc.

As noted, in choosing a plan, the individual may attach great importance to non-economic factors, such as the quality, variety and location of plan doctors, the convenience and historical accuracy of claims processing, the financial strength and stability of the plan, etc. Preferably, the software of the present invention contains links to sources of information which the individual may find useful in assessing the non-economic factors.

In addition, the software of the present invention is useful in planning expenditures relative to a flexible benefit plan. This may include tracking, displaying and reminding the user about expenditures that are not covered by other plans, estimating, during the course of a plan period, the rate at which the flex plan balance is being used, and providing reminders concerning deadlines, etc.

The embodiments described above are illustrative of the present invention and are not intended to limit the scope of the invention to the particular embodiments described. Accordingly, while one or more embodiments of the invention have been illustrated and described, it will be appreciated that various changes can be made therein without departing from the spirit or essential characteristics thereof. Accordingly, the disclosures and descriptions herein are intended to be illustrative, but not limiting, of the scope of the invention, which is set forth in the following claims.

1. A software program for reconciling health care benefits comprising:
a subroutine for entering payment rules of at least one health benefit plan into a computer storage system,
a subroutine for entering transaction data for a medical event associated with an individual covered by said health benefit plan into said computer storage system,
a subroutine for determining the amount of payment said health benefit plan is required to provide for said medical event and for identifying who is entitled to receive said benefit payment,
a subroutine for reconciling that the correct benefit payment amount has been provided by said health benefit plan to the correct payee,
a subroutine for alerting a user of any error in the benefit payment and for providing the user with at least one option for following up on said error.

2. The software program of claim 1 further comprising subroutines for entering personal information about a plurality of individuals and payment rules for a plurality of health benefit plans.

3. The software program of claim 1 wherein said subroutine for alerting a user of a benefit payment errors comprises providing the user with a plurality of possible follow-up options.

4. The software program of claim 3 wherein said plurality of possible follow-up actions comprises:
instructing the software to issue a reminder a reminder at a future date,
generating an automated inquiry to the health benefit plan, and
informing the user of the health benefit plan appeal process.

5. The software program of claim 1 further comprising a subroutine for calculating the amount of potentially compensable out-of-pocket health related expenses available from a secondary plan during a predetermined period.

6. The software program of claim 5 wherein said out-of-pocket expenses are potentially reimbursable under a flexible benefit plan, and further comprising subroutines for tracking the status of claims filed with said flexible benefit plan, for reconciling payments received from said flexible benefit plan and for calculating the balance of said flexible benefit plan.

7. The software program of claim 1 further comprising a subroutine for maintaining the health records of an individual.

8. The software program of claim 1 wherein said subroutine for entering the payment rules of at least one health benefit plan comprises a program wizard.

9. The software program of claim 1 wherein said subroutine for entering the payment rules of at least one health benefit plan comprises a subroutine for downloading the payment rule data from a remote computer.

10. A software program for reconciling health care benefits comprising:
a subroutine for entering payment rules of a plurality of health benefit plans into a computer storage system accessible to the software program,
a subroutine for entering personal information about a plurality of individuals into a computer storage system accessible to the software program,
a subroutine for entering payee information associated with persons who are entitled to receive benefit payments under said health benefit plans,
a subroutine for entering transaction data for medical events associated with said individuals into a computer storage system accessible to the software program,
a subroutine for determining whether a medical event entered into said computer storage system is covered by one or more of said health benefit plans and the amount of payment and identity of the payee each health benefit plan is required to provide for said medical event.

11. The software program of claim 10 further comprising a subroutine for tracking for each individual entered into said computer storage system the total payments made by each health benefit plan to each of said payees.

12. The software program of claim 11 wherein said subroutine for tracking total payments comprises a subroutine for providing a subtotal of payments associated with an individual over a user-selectable period of time.

13. The software program of claim 12 wherein said user-selectable period of time spans more than one annual period.

14. The software program of claim 11 further comprising a subroutine for comparing the benefits available under a first health benefit plan with the benefits available under a second health benefit plan for a selected set of medical events occurring in a predetermined period.

15. The software program of claim 11 further comprising a subroutine for accessing and downloading data from a remote computer maintained by a third party.

16. The software program of claim 15 wherein said downloaded data comprises health benefit plan information.

17. The software program of claim 15 wherein said downloaded data comprises explanation of benefits information.

18. The software program of claim 15 wherein said downloaded data comprises payment information relating to medical events.

19. A software program for managing health care benefits comprising:
a subroutine for entering payment rules of at least one health benefit plan into a computer storage system accessible to the software program,
a subroutine for entering payee information associated with at least one person who is entitled to receive benefit payments under said health benefit plan,
a subroutine for entering prescription data for medicines prescribed to said individual into a computer storage system accessible to the software program, said prescription data including prescription renewal data and prescription source data;
a subroutine for making available to the software user information concerning the need to renew prescriptions, applicable rules associated with prescription renewal under the health benefit plan, and the estimated cost of renewal.

20. The software of claim 19 further comprising a subroutine for communicating with a remote computer maintained by prescription filler.

21. The software of claim 20 wherein said subroutine for communicating comprises a subroutine for ordering a prescription refill.

22. The software of claim 21 wherein said subroutine for communicating comprises a subroutine for furnishing information about the health benefit plan to the remote computer.

23. A software program for tracking health care benefits comprising:
a subroutine for entering payment rules of at least one health benefit plan into a computer storage system,
a subroutine for entering transaction data for medical events associated with at least one individual covered by said health benefit plan into said computer storage system,
a subroutine for identifying whether a medical event is compensable under said health benefit plan and for determining the identify of the payees entitled to receive compensation under said health benefit plan,
a subroutine for providing status information about payments said health benefit plan is required to provide for said medical event,
a subroutine for alerting the user of status information about benefit payments associated with said medical event.

24. The software of claim 23 wherein said status information comprises identification of:
whether the health benefit plan has made any payment for the medical event,
each person who is entitled to receive payment under the health benefit plan and the amount of such payment,
each payee who has received payment and the amount of payment made to each such payee.

25. The software of claim 23 further comprising a subroutine for entering payments made by the individual insured under said health benefit plan in connection with the medical event.

26. The software of claim 23 further comprising a subroutine for tracking payments that the individual user is required to make under said health benefit plan in connection with the medical event.

27. The software of claim 23 further comprising a subroutine for comparing payments made and payments owed for said medical event, and alerting the user of the reconciliation status.

28. The software of claim 23 further comprising a subroutine for tracking out-of-pocket expenses associated with a plurality of medical events.

29. The software of claim 23 wherein said subroutine for entering said payment rules comprises a wizard.

30. The software program of claim 23 wherein said subroutine for entering the payment rules of at least one health benefit plan comprises a subroutine for downloading the payment rule data from a remote computer which maintains the health benefit plan payment rules.

31. The software program of claim 23 further comprising a subroutine for downloading payment information relating to a medical event from a remote computer.

32. The software program of claim 28 further comprising a subroutine for generating reports associated with health benefit payments and out-of-pocket expenses.

33. The software program of claim 29 wherein said report generating subroutine is capable of providing a report of tax-deductible medical expenses.

34. The software program of claim 33 wherein said report generating subroutine is capable of generating a report which is in a form that can be submitted to a governmental tax authority.

35. The software program of claim 23 comprising a relational database having data fields for storing information in a computer storage system for a plurality individuals, a plurality of health benefit plans, a plurality of medical events, a plurality of payment types and a plurality of payment transactions.

36. The software program of claim 35 comprising a plurality of wizards for facilitating user entry of information into said database.

37. The software program of claim 35 further comprising a subroutine for projecting and comparing the benefits available under at least two different health benefit plans based on the data relating to the medical events stored in the computer storage system.

38. The software program of claim 37 further wherein said subroutine for projecting and comparing benefits takes into account a user's estimate of the medical events likely to occur with a predetermined period.

39. A software program for assisting a user realize the available benefits under at least one health benefit plan and at least one flexible spending account, which may be used to provide supplement benefits, wherein said flexible spending account has a plan coverage period, comprising:
a subroutine for entering data about the medical events occurring during the plan coverage period and storing said medical event data in a computer storage system,
a subroutine for tracking the benefits paid by said health benefit plan during said plan coverage and storing said benefit payment information in a computer storage system,
a subroutine for tracking payments received from said flexible spending account during said plan period and storing said data in a computer storage system,
a subroutine for tracking out-of-pocket expenses paid in connection with said medical events and storing said data in a computer storage system,
a subroutine for calculating and reporting the amount available in said flexible spending account for the current plan period.

40. The software of claim 39 further comprising a subroutine for tracking unpaid benefits amounts owed to the insured under said health benefit plan and wherein said subroutine of calculating and reporting the amount available in said flexible spending account reports the amount balance of payments due to the insured.

41. The software of claim 39 further comprises a subroutine for alerting the user of the status of the flexible spending account and of the deadline for using any remaining balance in said flexible spending account.

42. The software of claim 39 wherein said subroutine for alerting the user is triggered by user definable events.

43. The software of claim 41 wherein said subroutine for alerting the user is triggered at specific time intervals during the plan period.

44. The software of claim 43 wherein said time intervals grow shorter as the end of the plan period approaches.

45. The software of claim 41 further comprising a subroutine for entering plan information about the flexible spending account into a computer storage system, and wherein at least one of said user alerts advises the user of possible uses of the remaining balance in the flexible spending account.

46. The software of claim 39 further comprising a subroutine for preparing a claim submission to said flexible spending plan.

47. The software of claim 46 wherein said claim submission is a paper claim form.

48. The software of claim 46 wherein comprising a subroutine for submitting said claim electronically.
